(19) United States
(12) Patent Application Publication
(10) Pub. No.: US 2026/0139790 A1
(43) Pub. Date: May 21, 2026

(54) SUPPORT ASSEMBLIES AND COMPONENTS FOR SUCH ASSEMBLIES

(71) Applicant: Archi Enterprises Inc., North Vancouver (CA)

(72) Inventors: Christian Alexander LeBlanc, Vancouver (CA); Michael Foster, Vancouver (CA)

(73) Assignee: Archi Enterprises Inc., North Vancouver (CA)

(21) Appl. No.: 18/955,208

(22) Filed: Nov. 21, 2024

(51) Int. Cl. F16M 11/42; F16M 11/04; F16M 11/20

(52) U.S. Cl. CPC F16M 11/42; F16M 11/046; F16M 11/2014; F16M 11/2092; F16M 2200/024; F16M 2200/047

(57) ABSTRACT

An assembly for moving a device includes roller elements for allowing the assembly to be moved by rolling the roller elements, a vertical track assembly comprising a device mount assembly for mounting the device to the vertical track assembly, a counterbalanced pulley system for allowing the device mount assembly to be controllably translated along the vertical track assembly, and a turntable, at least a portion of which is rotatable relative to the vertical track assembly.

### TECHNICAL FIELD

The present disclosure relates to the field of support assemblies and components for such assemblies. In particular, the present disclosure relates to modular stand components, track components, track roller components, turntable components, and pulley components for demountable engagement into various configurations of track, dolly, and/or stand assemblies for use in operation and/or conveyance of devices such as cameras, lighting equipment, sound recording equipment, audio/visual equipment, sensors, robotic gimbals, robotic arms, power tools, and other equipment.

### BACKGROUND

Support apparatuses of various types are required in every industry and range in both size and complexity in order to meet the specific needs of a particular industry or worksite. Irrespective of the industry, most support apparatuses are designed to have a single function. Consequently, a variety of apparatuses are required to meet various needs.

The film and video production industry is one example of such an industry requiring various specialized support apparatuses. Techniques in production including cinematography, videography, lighting, sound capture, and motion capture, for example, depend on a wide range of support apparatuses that provide technicians with the means to do their work. Additionally, given the regularly changing worksites of film and video productions, ease of portability is essential.

Various types of support apparatuses are available and widely used. Some commonly used apparatuses include, for example, jibs or cranes which allow for vertical and sideways movement from low to high angles. Various types of dollies ranging in size from large to more compact allow for smooth rolling movements along the ground or on track assemblies. Sliders which are essentially a condensed, mountable version of a dolly on a supported track also provide smooth movement along a straight path.

Each type of support apparatus is designed to allow cameras and other devices to reach certain angles and/or to perform specific motions, often with consideration of the potential challenges or limitations that may exist in various working locations. The versatility of each type of support apparatus is therefore limited and often results in the need to employ multiple apparatuses depending on the work requirements despite being often for generally similar functions.

Although current technologies attempt to address limitations in portability configurability of support apparatuses, in various industries there continues to be a need for apparatuses that are easy to transport and to assemble, while also offering functional versatility.

### SUMMARY

The present disclosure generally relates to support assemblies and apparatuses for engagement, manipulation, and operation of devices such as cameras, lighting equipment, sound recording equipment, audio/visual equipment, sensors, robotic gimbals, robotic arms, power tools, and other equipment. More specifically, according to some embodiments of the disclosure, components may be assembled into support apparatuses for providing stable and moveable engagement of various devices having a range of operational requirements and which may be for temporary use on a worksite or location, wherein the apparatuses can be configured and quickly assembled by interconnecting and securely engaging a plurality of modular structural support components along with a selection of modules designed for mounting, moving, and operating of various devices and equipment. The support apparatuses may comprise dolly assemblies with wheels or track roller assemblies for controlled movement along straight or curved track assemblies. After the need for a support apparatus is completed on a worksite or location, it can be quickly and easily disassembled into the individual modular elements that can be collected for transport or storage.

Some embodiments of the present disclosure relate to dolly apparatuses comprising a turntable base and rollers or wheels for rolling along the ground or on track assemblies. Track roller assemblies are configured for engagement along cylindrical rails or square rails or rectangular rails of various track assemblies which may comprise a single or parallel pair of elongate rail components of a type, or a single series or two parallel series of elongate rail components of a type assembled end to end where extended travelling distance on a track assembly is required. A track assembly may be supported by a base comprising a plurality of cylindrical structural components and other components such as weight components as well as foot components or wheel components on which the track assembly can be adjustably levelled.

According to some embodiments, the turntable dolly base may be upwardly engaged by a vertical track assembly for vertical motion or a vertical adjustment assembly for static vertical positioning of a device mount assembly whereon various devices or equipment may be demountably engaged. A vertical track assembly may comprise pulley components for controlling movement of roller carriage assemblies and supported device mount components along vertical rails of the vertical track assembly. The weight of the supported equipment, mount assembly and its supporting roller carriage(s) may be nearly or equally matched at the opposite end of the pulley assembly's cable by a roller carriage with demountable weight components so that the assemblies and supported equipment will remain static at any position along the vertical rails until moved by the operator. Optionally, one or more clamping mechanisms may apply adjustable pressure of a friction pad against the vertical rail component(s) to slow the movement or be fully engaged to temporarily lock the carriage assembly and supported device or equipment at any position along the vertical rail.

Alternatively a turntable dolly base may be upwardly engaged with a tiltable jib arm assembly for positioning and moving a device along any axis and, like a vertical track assembly, may provide a range of positioning and motion of a device from very low to high angles. A jib arm assembly may be rotatable centrally where it is mounted to a vertical support structure above the turntable dolly base, and may comprise at one end counterbalance weight components and at the opposite end a self-levelling device mount assembly whereon the device is mounted.

According to further embodiments, several of the modular components of the present disclosure relate to portable stands whereon various devices or a table component may be mounted and positioned and the device stand may be optionally reconfigured for a change of position or function.

According to a first aspect of the disclosure, there is provided an assembly for moving a device, comprising: roller elements for allowing the assembly to be moved by rolling the roller elements; a vertical track assembly comprising a device mount assembly for mounting the device to the vertical track assembly; a counterbalanced pulley system for allowing the device mount assembly to be controllably translated along the vertical track assembly; and a turntable, at least a portion of which is rotatable relative to the vertical track assembly.

The assembly may further comprise roller assemblies comprising the roller elements, and the roller assemblies may be connected by one or more connecting members to the turntable and positioned to allow the roller elements to contact rails of a track along which the assembly is to be moved.

Each roller assembly may have a portion that is pivotable relative to the one or more connecting members to thereby assist the assembly in moving along a curved portion of the track.

Each roller assembly may comprise at least a pair of the roller elements a roller element mount plate to which are fastened the pair of roller elements. The roller element mount plate may comprise multiple spaced apertures for allowing the pair of roller elements to be spaced apart by different offsets to accommodate rails of different widths.

The assembly may comprise one or more cylindrical structural components, each cylindrical structural component having one or more channels formed in an outer surface thereof and extending along the length of the cylindrical structural component.

At least one of the one or more cylindrical structural components may have only four channels, and the four channels may be positioned symmetrically around the cylindrical structural component.

The assembly may further comprise a track along which the assembly is to be moved, and the track may comprise at least one of the one or more cylindrical structural components.

The vertical track assembly may comprise at least one of the one or more cylindrical structural components.

The assembly may further comprise roller assemblies comprising the roller elements, and the roller assemblies may be connected by one or more connecting members to the turntable and positioned to contact rails of a track along which the assembly is to be moved. The one or more connecting members may comprise at least one of the one or more cylindrical structural components.

The assembly may comprise multiple cylindrical structural components, and at least two adjacent cylindrical structural components of the multiple cylindrical structural components may be joined using a brace positioned in a respective channel of each of the two adjacent cylindrical structural components.

The turntable may define a first axis of rotation, and the device mount assembly may comprise a device mount plate for mounting the device at a mounting location on the device mount plate. The mounting location may be aligned with the first axis of rotation.

The vertical track assembly may comprise one or more vertical rails along at least one of which the device mount assembly is controllably and vertically translatable using the pulley system. The one or more vertical rails may be offset from a center of the turntable by one or more extension members to align the first axis of rotation with the mounting location.

The vertical track assembly may comprise one or more vertical rails along at least one of which the device mount assembly is controllably and vertically translatable using the pulley system. The one or more vertical rails may be attached to the turntable.

The vertical track assembly may comprise vertical rails, and the device mount assembly may be attached to at least one of the vertical rails using at least one first roller carriage assembly configured to be controllably translated along the at least one vertical rail. The pulley system may comprise a counterweight secured to at least one of the vertical rails by at least one second roller carriage assembly, and may be connected to the at least one first roller carriage assembly and the at least one second roller carriage assembly.

The vertical track assembly may comprise first, second, and third vertical rails, and the device mount assembly may be controllably and vertically translatable, using the pulley system, along the first and second vertical rails. The pulley system may comprise a counterbalance that is controllably and vertically translatable along the third vertical rail.

The pulley system may comprise a pulley plate and one or more pulleys mounted to the pulley plate, and the vertical track assembly may further comprise one or more vertical rails to which is secured the pulley plate.

The vertical track assembly may further comprise at least one corner brace contacting the pulley plate and one of the one or more vertical rails to provide increased support to the pulley plate.

The assembly may further comprise the track, and the track may comprise at least one rail connecting member interconnecting the rails. One or more wheels may be attached to the rail connecting member for allowing the track to be rolled along the ground.

Each wheel may be attached to a respective vertical post comprised in the rail connecting member, and each vertical post may be spaced from one of the rails to provide clearance for the rolling assemblies when the assembly is being moved along the track.

Each vertical post may be attached to one of the rails using a respective connector comprised in the rail connecting member. Each connector may be configured to be attached to the one of the rails using a fastener received in a first channel formed within the one of the rails, and each connector may be configured to be attached to the vertical post using a fastener received in a second channel formed within the vertical post.

The first and second channels may be perpendicular.

The rail connecting member may be height-adjustable relative to each wheel for allowing the track to be levelled.

The assembly may further comprise the track, and at least one of the rails may be fastened to a vertical post of the track. A wheel may be attached to the vertical post for allowing the track to be rolled along the ground, and the height of the rail relative to the wheel may be adjustable by adjusting the location at which the rail is fastened to the vertical post.

The rail may be fastened to the vertical post using at least one connector, and the height of the rail relative to the wheel may be adjustable by unfastening the at least one connector, adjusting the location at which the rail is fastened to the vertical post, and fastening the at least one connector to the vertical post and the rail.

The at least one connector may be at least one corner brace connector.

At least one of the one or more connecting members may comprise a cylindrical structural component, and at least one of the rolling assemblies may be attached to the at least one cylindrical structural component using a connector having: a first end that is fastened to the rolling assembly; and a second end that covers an open end of the cylindrical structural component.

The roller elements may be wheels for wheeling the assembly over the ground.

The assembly may further comprise a horizontal base extending from a front of the assembly to a rear of the assembly, and the vertical track assembly may be attached to the horizontal base at the front of the assembly.

One or more diagonal supporting members may extend from proximally the rear of the assembly to proximally a top of the vertical track assembly.

The vertical track assembly may comprise a pair of vertical rails along which the device mount assembly is controllably and vertically translatable using the pulley system, and the one or more diagonal supporting members may be attached to the pair of vertical rails.

The wheels may include at least one rear wheel, and the turntable may be coupled to the at least one rear wheel such that a user of the assembly may rotate the turntable and thereby pivot the at least one rear wheel to steer the assembly.

The turntable may comprise a first plate rotatable relative to a second plate.

The turntable may further comprise one or more rollers between the first and second plates for allowing the first plate to rotate relative to the second plate.

The turntable may further comprise a bearing positioned between the first and second plates.

The turntable may further comprise rollers between the first and second plates and arranged in a circumferential direction for allowing the first plate to rotate relative to the second plate.

The turntable may further comprise: a first movable disc on top of the first plate, and a second movable disc between the first and second plates; and a threaded fastener extending through the first movable disc, the first plate, the second movable disc, and the second plate, and for allowing a user to control the resistance to rotation, or prevent rotation, of the first plate relative to the second plate by selectively tightening or loosening the fastener.

The turntable may further comprise: a bearing retainer positioned between the bearing and one of the first plate and the second plate; and a threaded fastener extending through the other of the first plate and the second plate, into the bearing retainer, and for allowing a user to control the resistance to rotation, or prevent rotation, between the first and second plates by selectively tightening or loosening the fastener.

According to a further aspect of the disclosure, there is provided a roller assembly for moving along a rail, comprising: an upper mount component; an upper body component pivotable relative to the upper mount component; a lower body component fixed to the upper body component; and a roller element mount plate to which are secured roller elements for allowing the assembly to be moved by rolling the roller elements along the rail, wherein the roller element mount plate is: pivotable relative to the lower body component; and translatable along a slot formed in the lower body component.

According to a further aspect of the disclosure, there is provided a connector for connecting first and second cylindrical structural components, comprising: a first connector portion for fastening to the first cylindrical structural component; and a second connector portion for fastening to the second cylindrical structural component, and wherein: the first and second connector portions are fastened together using a threaded fastener; and the connector further comprises a resiliently compressible material provided between the first and second connector portions to provide increased tension to a user when fastening the first and second cylindrical structural components together using the threaded fastener.

The resiliently compressible material may be a single resiliently compressible ring received in a corresponding recess in one of the first and second connector portions.

The single resiliently compressible ring may be received in a corresponding recess in the first connector portion and a corresponding recess in the second connector portion.

The resiliently compressible material may comprise a pair of resiliently compressible rings received in corresponding recesses in the first and second connector portions.

Each resiliently compressible ring may protrude from its respective recess.

The resiliently compressible material may be adhered to one or both of the first and second connector portions.

One of the first and second connector portions may comprise a recess, and the other of the first and second connector portions may comprise a locking member movable through an aperture in the other of the first and second connector portions and into the recess to prevent the first and second connector portions from being unfastened by rotation of the first and second connector portions relative to one another.

Each of the first and second connector portions may comprise a respective threaded aperture for receiving the threaded fastener when fastening together the first and second connector portions.

According to a further aspect of the disclosure, there is provided an assembly comprising: a vertical adjustment assembly comprising: one or more vertical posts; and a device mount assembly comprising one or more arms fastened to the one or more vertical posts and for mounting a device to the vertical adjustment assembly; and a turntable, at least a portion of which is rotatable relative to the vertical adjustment assembly, and wherein the one or more arms are height-adjustable relative to the ground to allow the device mount assembly to be vertically repositioned.

The assembly may further comprise a horizontal base extending from a front of the assembly to a rear of the assembly, and the vertical adjustment assembly may be attached to the horizontal base at the front of the assembly.

One or more diagonal supporting members may extend from proximally the rear of the assembly to proximally a top of the vertical adjustment assembly.

The vertical adjustment assembly may comprise a pair of vertical posts along which the device mount assembly is vertically adjustable, and the one or more diagonal supporting members may be attached to the pair of vertical posts.

The assembly may further comprise wheels, including at least one rear wheel, for allowing the assembly to be moved over the ground, and the turntable may be coupled to the at least one rear wheel such that a user of the assembly may rotate the turntable and thereby pivot the at least one rear wheel to steer the assembly.

Each of the one or more arms may be attached to one of the one or more posts using at least one connector, and the height of each arm relative to the ground may be adjustable by unfastening the at least one connector, adjusting the location at which the arm is fastened to the vertical post, and fastening the at least one connector to the vertical post and the arm.

The at least one connector may be at least one corner brace connector.

The turntable may define a first axis of rotation, and the device mount assembly may comprise a device mount plate for mounting the device at a mounting location on the device mount plate. The mounting location may be aligned with the first axis of rotation.

The vertical adjustment assembly may comprise one or more vertical posts along at least one of which the device mount assembly is height-adjustable, and the one or more vertical posts may be offset from a center of the turntable by one or more extension members to align the first axis of rotation with the mounting location.

According to a further aspect of the disclosure, there is provided a stand for a device, comprising: a base; an upright support fastened to the base; and an arm fastened to the upright support and comprising a mount for receiving the device, wherein: one or any combination of the base, the upright support, and the arm comprises one or more cylindrical structural components, each cylindrical structural component having one or more channels formed in an outer surface thereof and extending along the length of the cylindrical structural component; at least one of the one or more cylindrical structural components has only four channels; and the four channels are positioned symmetrically around the cylindrical structural component.

The base may comprise one or more wheels for moving the stand.

The base may comprise: a first member; and a second member fastened perpendicularly to: the first member; and the upright support.

The second member may be fastened to the first member using one or more first connectors. The second member may be fastened to the upright support using one or more second connectors.

The one or more first connectors and/or the one or more second connectors may be one or more corner braces.

The base may further comprise two wheels connected to the first member.

The base may further comprise a single wheel connected to the second member.

The upright support may comprise at least two interconnected cylindrical structural components of the one or more cylindrical structural components.

The two interconnected cylindrical structural components may be interconnected using a connector comprising: a first connector portion fastened to one of the two cylindrical structural components; and a second connector portion fastened to the other of the two cylindrical structural components. The first and second connector portions may be fastened together using a threaded fastener.

The connector may further comprise a resiliently compressible material provided between the first and second connector portions to provide increased control to a user when fastening the first and second connector portions together using the threaded fastener.

The arm may be height-adjustable relative to the ground by adjusting a location at which the arm is fastened to the upright support.

The stand may further comprise a clamp clamped to the upright support and to which is fastened the arm.

The clamp may be configured to be repositionable on the upright support by unfastening a single fastener to loosen the clamp and then translating the clamp along the upright support.

The mount may comprise a ball-and-socket joint.

The stand may further comprise a clamp clamped to the arm and to which is fastened the mount.

The clamp may be configured to be repositionable on the arm by unfastening a single fastener to loosen the clamp and then translating the clamp along the arm.

Each of the base, the upright support, and the arm may comprise at least one cylindrical structural component of the one or more cylindrical structural components.

According to a further aspect of the disclosure, there is provided a stand for a device, comprising: a base; an upright support fastened to the base; an arm fastened to the upright support and comprising a mount for receiving the device; and a clamp clamped to the upright support and to which is fastened the arm.

The clamp may be configured to be repositionable on the upright support by unfastening a single fastener to loosen the clamp and then translating the clamp along the upright support.

According to a further aspect of the disclosure, there is provided an adjustable-level track assembly comprising: vertical posts; a pair of spaced-apart rails connected to the vertical posts; at least two rail-connecting members interconnecting the rails; and ground-contacting elements connected to the vertical posts and the rail-connecting members, wherein the height of the ground-contacting elements relative to the rails is adjustable by adjusting the locations at which the rails are connected to the vertical posts.

For at least one of the rails, the rail may be fastened to one of the vertical posts using at least one connector. The height of the rail relative to at least one of the ground-contacting elements may be adjustable by unfastening the at least one corner brace, adjusting the location at which the rail is fastened to the vertical post, and fastening the at least one corner brace to the vertical post and the rail.

The at least one connector may be at least one corner brace.

The ground-contacting elements may be wheels or static feet.

For at least one of the vertical posts, the height of the at least one vertical post relative to the ground-contacting element to which it is connected is adjustable using a threaded connector.

According to a further aspect of the disclosure, there is provided a base for a vertical adjustment assembly, comprising: legs extending from a cylindrical mount component; feet connected to ends of the legs; and a plate rotatable relative to the legs and connected to the cylindrical mount component by a threaded fastener extending through the plate and into the cylindrical mount component, and for allowing a user to control the resistance to rotation of the plate by selectively tightening or loosening the fastener.

The threaded fastener may further extend through the cylindrical mount component and a locking nut is engaged with the threaded fastener to lock the plate.

Three or four legs may extend from the cylindrical mount component.

The legs may be height-adjustable relative to the feet.

The feet may be threadably engaged to cylindrical mount portions at ends of the legs.

The legs may be height-adjustable relative to the feet by threadably adjusting positions of the feet relative to the cylindrical mount portions.

The feet may comprise caster wheels.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

These and other features of the disclosure will become more apparent in the following detailed description in which reference is made to the appended drawings, wherein:

FIG. 1 is a perspective view of a vertical track dolly comprising a 3-rail vertical track assembly with pulley and counterweighted device mount components supported on a turntable dolly base and adjustable-level horizontal track assembly, according to an embodiment of the disclosure;

FIG. 2 is a partially exploded perspective view of the 3-rail vertical track assembly shown in FIG. 1;

FIG. 3 is a partially exploded perspective view of the pulley component assembly shown in FIG. 1;

FIG. 4 is a partially exploded perspective view of the turntable dolly base with four track roller assemblies shown in FIG. 1;

FIG. 5 is a partially exploded perspective view of the lockable turntable assembly of the turntable dolly base shown in FIG. 1;

FIG. 6 is a partially exploded perspective view of one of the track roller assemblies of the turntable dolly base shown in FIG. 1 configured on the cylindrical rail track assembly;

FIG. 7 is a partially exploded perspective view of the cylindrical rail track assembly shown in FIG. 1;

FIG. 8 is a perspective view of a vertical track dolly with a turntable dolly base on a rectangular rail track assembly, according to an embodiment of the disclosure;

FIG. 9 is a top perspective view of the turntable dolly base with four track roller assemblies shown in FIG. 8 configured on the rectangular rail track assembly;

FIG. 10 is a partially exploded bottom perspective view of the turntable dolly base and four track roller assemblies shown in FIG. 9;

FIGS. 11A and 11B are a whole perspective view and a partially exploded perspective view of one of the track roller assemblies shown in FIG. 8 configured for a rectangular or square rail;

FIG. 12 is a perspective view of a height-adjustable dolly comprising three vertical posts and device mount components supported on a turntable dolly base on standard straight and curved horizontal track components, according to an embodiment of the disclosure;

FIG. 13 is a partially exploded perspective view of the turntable dolly base shown in FIG. 12 with a lockable turntable assembly and four cylindrical rail track roller assemblies;

FIG. 14 is a partially exploded perspective view of the vertical adjustment assembly shown in FIG. 12 with three vertical posts mounted on three turntable extension plates;

FIG. 15 is a perspective view of an adjustable-level tripod stand supporting a vertical track assembly on a rotation plate assembly, according to an embodiment of the disclosure;

FIG. 16 is a partially exploded perspective view of the adjustable-level tripod stand and rotation plate assembly shown in FIG. 15;

FIG. 17 is a perspective view of a steerable vertical track dolly with a vertical track assembly supported on a horizontal chassis assembly mounted to a fixed front axle assembly and rotating rear axle assembly;

FIG. 18 is a partially exploded perspective view of the steerable vertical track dolly shown in FIG. 17, according to an embodiment of the disclosure;

FIG. 19 is a partially exploded perspective view of the horizontal chassis assembly, fixed front axle assembly, and rotating rear axle assembly shown in FIG. 17;

FIGS. 20A and 20B are a whole perspective view and an exploded perspective view of one of four of an adjustable angle connector shown in FIG. 17 configured for reinforcing the vertical track assembly;

FIG. 21 is a perspective view of a rotating jib dolly with a vertically pivotable jib arm assembly and self-levelling device mount assembly on a vertical support assembly and turntable dolly base configured for straight and curved track components, according to an embodiment of the disclosure;

FIG. 22 is a partially exploded perspective view of the jib arm assembly, self-levelling device mount assembly, and vertical support assembly shown in FIG. 21;

FIG. 23 is a partially exploded perspective view of the turntable dolly base shown in FIG. 21;

FIG. 24 is a perspective view of a device stand with a demountable laptop bracket and cup holder component supported by structural tube modules with a first example of twist-on end assemblies, according to an embodiment of the disclosure;

FIG. 25 is a partially exploded perspective view of the device stand in FIG. 24;

FIG. 26 is a perspective view of a table stand with a demountable table assembly, according to an embodiment of the disclosure;

FIG. 27 is a partially exploded perspective view of the table stand in FIG. 26;

and

FIGS. 28A and 28B are a whole perspective view and an exploded perspective view of a second example of twist-on end assemblies, according to an embodiment of the disclosure.

### DETAILED DESCRIPTION

The present disclosure seeks to provide novel support assemblies and components for such assemblies. While various embodiments of the disclosure are described below, the disclosure is not limited to these embodiments, and variations of these embodiments may well fall within the scope of the disclosure which is to be limited only by the appended claims.

The support assemblies and apparatuses of the present disclosure may comprise a plurality of modules that may be demountably engaged into a wide assortment of combinations to form assemblies that can be used in various stationary and moveable equipment support applications. The assemblies may be easily disassembled into individual modular subassemblies and/or components to facilitate ease of transport and storage. The modular components may enable multi-functionality in that the various modules can be easily configured to form a unique apparatus and then quickly broken down for transport and/or storage and may be reconfigured into additional forms with alternative functionalities and ranges of motion. For the purposes of illustrating the versatility and configurability of these components and assemblies, the following non-limiting description will refer to examples of support assemblies that are useful for demountable engagement with devices such as cameras, lighting equipment, sound recording equipment, audio/visual equipment, sensors, robotic gimbals, robotic arms, power tools, and other equipment.

Embodiments of the present disclosure generally relate to modular components which, to configure modular support apparatuses of various types and utility, may be configured and sized for compatibility with the modular components as previously disclosed in U.S. Pat. No. 11,384,898 B2, US Patent Application Publication No. 2022/0299159 A1, U.S. Pat. No. 11,535,288 B2, and U.S. Pat. No. 11,987,280 B2, all of which are incorporated herein by reference in their entireties.

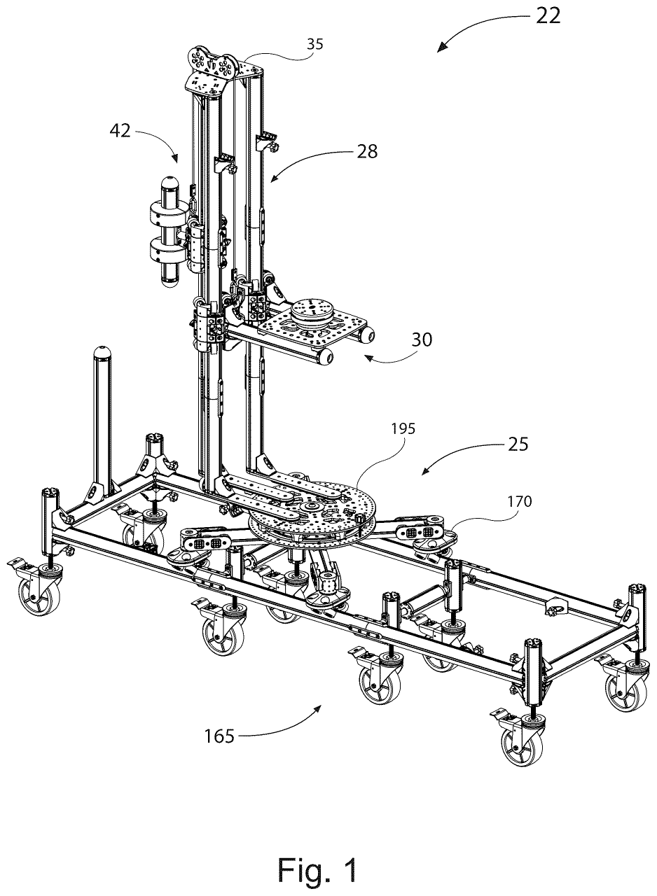

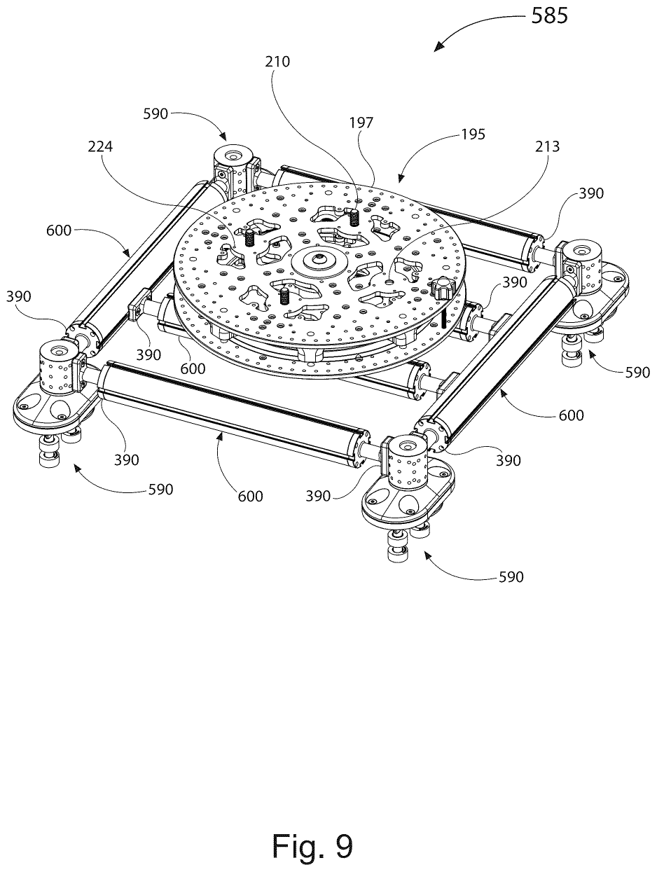

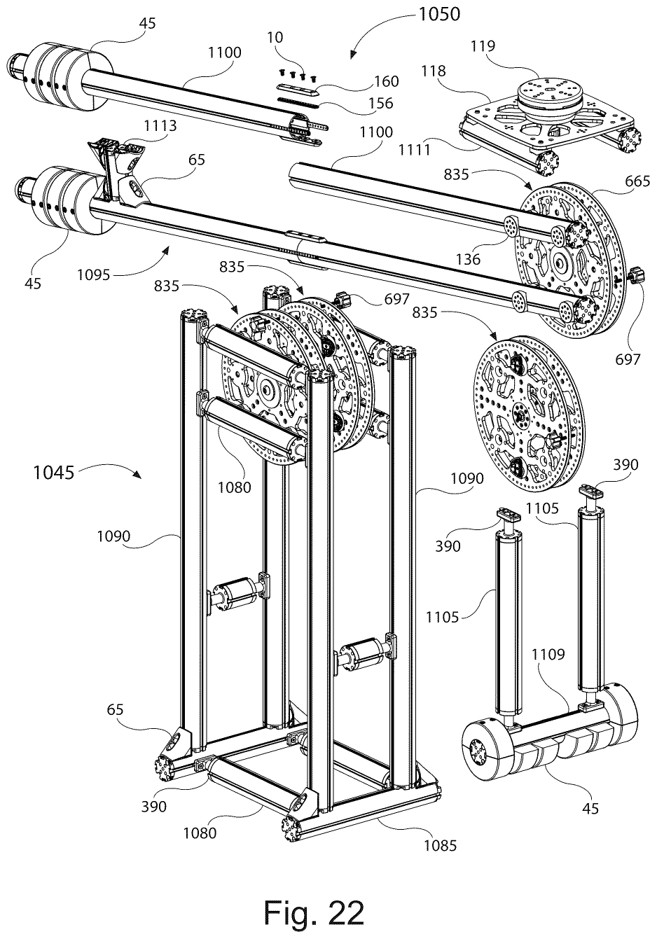

Embodiments of the modular components and support assemblies disclosed herein are described with reference to FIGS. 1-28 to illustrate various types of demountably engageable modules that may be securely and stably interconnected and assembled into a range of configurations for engaging, supporting, and conveying various types of devices or equipment in and around a film set or a production studio or a photography studio or a performance venue or a sporting venue, or other locations commonly used for producing movies, videos, television programs, sports, news, documentaries, music videos, time-lapse photography, and still photography. The modular components also form assemblies useful in other types of worksites such as in manufacturing, construction, landscaping, agricultural, healthcare, retail, warehouses and the like, or alternatively, for use in some household and recreational applications. According to some embodiments, the modular components may be sized to make them suitable for handling and use by juveniles during play and learning activities.

The numbers and types of modules that may be incorporated into a particular assembly will vary depending on the intended end-use of the support assembly. However, an assembly may generally comprise: a plurality of caster components and/or wheel components and/or roller components and/or foot components; a plurality of structural tube modules assembled together in part by screws threadedly engaged with nuts retained within nut channels along the sides of the structural tube modules; and a dolly base assembly which may comprise a turntable assembly for rotational movement of the top components of the support apparatus which may include a vertical track assembly or vertical adjustment assembly or a tiltable jib arm assembly, as will be described in further detail below.

According to some embodiments disclosed herein, a group of one or more of the various types of modules is provided together in a kit for assembly into a specified type of support apparatus configured for the given functional requirements. Kits of the present disclosure may additionally comprise, or be packaged with, instruments or tools for assisting with the assembly of the system, and/or hard copy or software based instructions for assembling the same.

The broad range of configurability allows apparatuses to be assembled in a wide range of sizes and functional design for a broad range of end-user requirements. According to certain embodiments, the modules can be interconnected to form apparatuses that include, without limitation, carts, dollies, tracks, cranes, jibs, lifts, stands, racks, tables, workstations, seating, bedframes, shelving, storage, staging, railings, partitions, toy systems, and the like. Optionally, an apparatus may be combined with third party tools, mechanisms, and systems for varying end-use requirements.

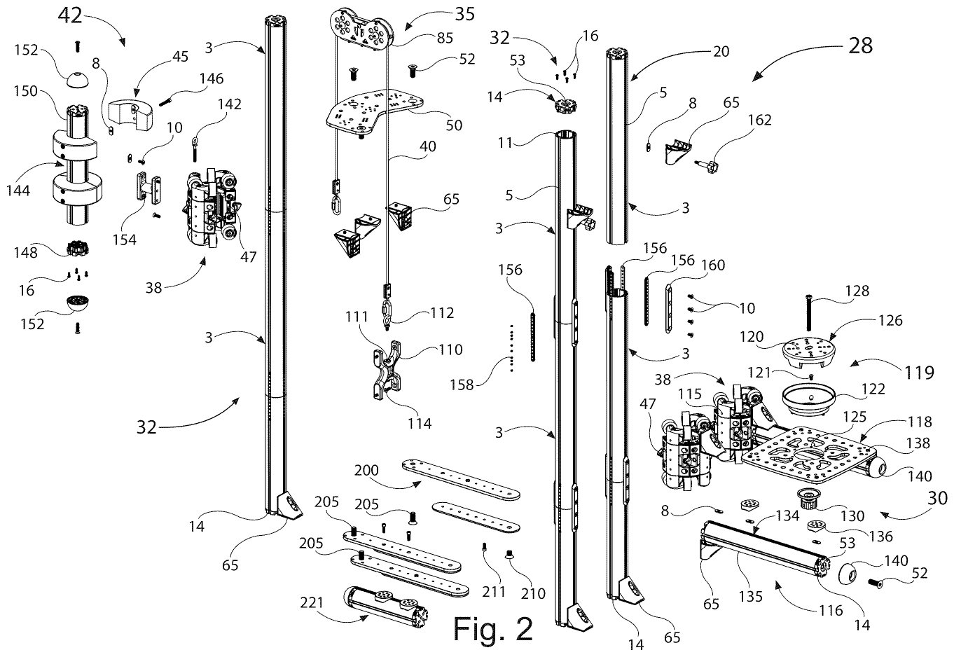

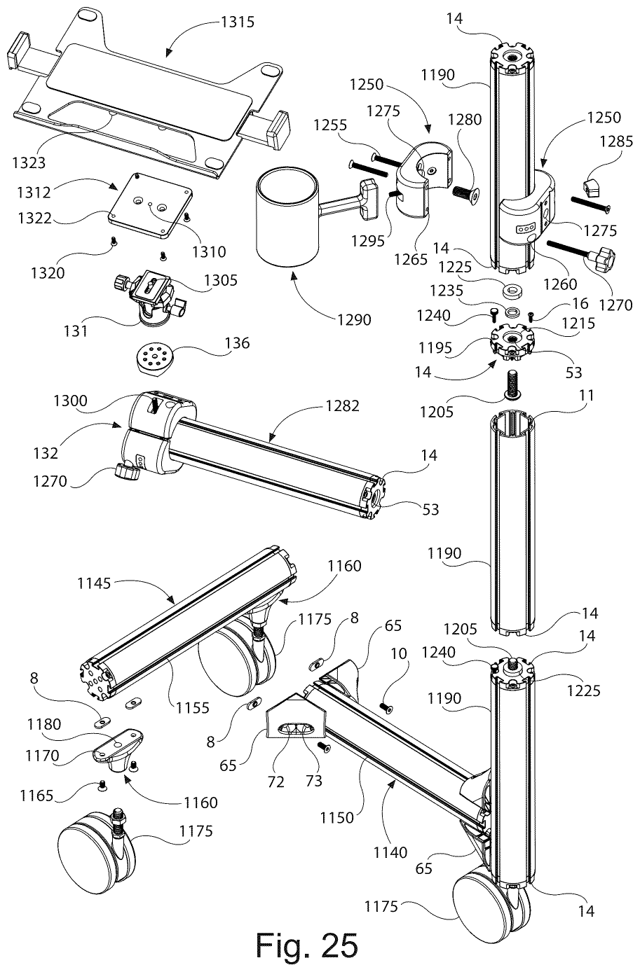

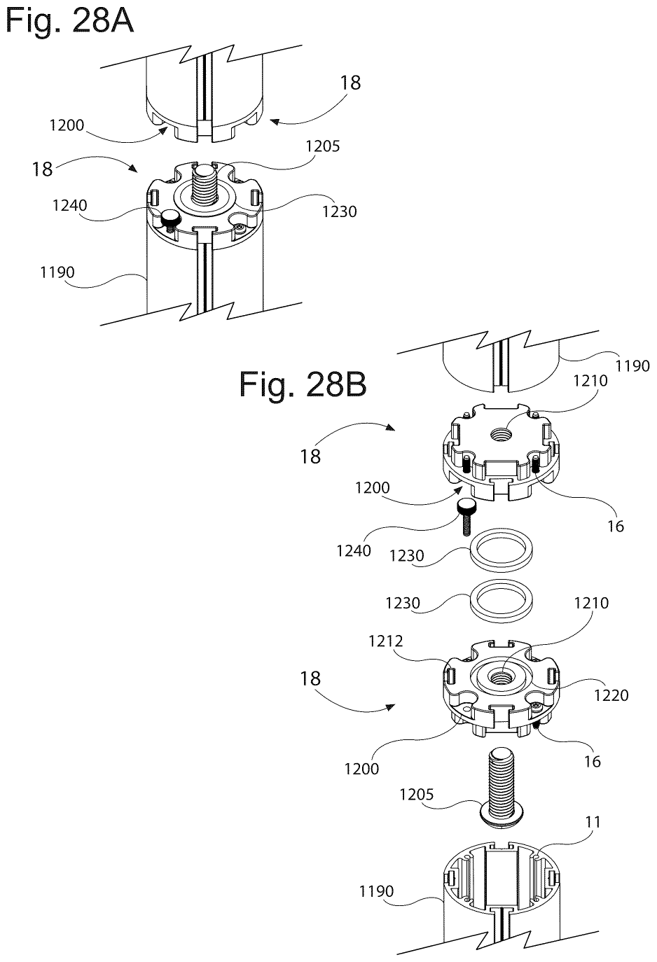

According to some embodiments, a modular apparatus comprises a plurality of elongate cylindrical structural components with one or more nut channels around its circumference wherein one or more components may be demountably engaged by screws or bolts threadedly engaged with nuts securely retained within the nut channels. As shown and first indicated in FIG. 2, and in close-up view in FIGS. 25 and 28, a cylindrical structural component 3 comprises four nut channels 5 whereby one or more nuts 8 may be threadedly engaged by one or more screws 10 to demountably engage another modular component having a concave face and configured to receive one or more screws or bolts for engagement with the one or more nuts 8.

A cylindrical structural component 3 may additionally comprise one or more screw slots 11 along the inner contours of the component whereby another component such as a threaded end connector 14 may be fastened to one or both ends by screws 16, as first indicated in FIG. 2 and shown in close-up in FIG. 25, or according to a further embodiment which will be described in further detail below with reference to FIG. 28, threaded end connector 18.

Various lengths of cylindrical structural components may be optionally combined with one or two end components of several types engaged at one or both ends of the cylindrical structural components to form various tube modules 20 which may be used in conjunction with one another and the other structural and functional components of the modular system such as corner brace connectors, and/or brace plates, and/or device mount plates, and/or pulley mount plates, and/or turntable components, and/or roller carriage assemblies, and/or weight components, and/or track roller assemblies, and/or wheel components, and/or foot mount components, as will be described in further detail below. Various lengths of cylindrical structural components may also be provided for direct attachment in a series of two or more secured end to end by channel braces or cylinder external braces to form rails and vertical posts, as will also be described in further detail below.

A first embodiment of a vertical track dolly is illustrated in FIGS. 1 to 7. The vertical track dolly 22 comprises a turntable dolly base 25 which is upwardly engaged by a vertical track assembly 28 configured for moving a device mount assembly 30 along vertical rail assemblies 32 of the vertical track assembly 28. The vertical track assembly 28 may comprise a pulley assembly 35 for controlling the positioning and movement of the device mount assembly 30 which in part comprises roller carriages 38, as previously disclosed in US Patent Application Publication No. 2022/0299159 A1, which are configured for stable rolling movement along the vertical rails 32.

The weight of a supported device or equipment and mount assembly 30, may be nearly or equally matched at the opposite end of the pulley assembly's cable 40 by a counterweight carriage assembly 42 comprising an additional roller carriage 38 with demountable weight components 45 attached so that the assemblies and supported device or equipment will remain static at any position along the vertical rails until moved by the operator. Optionally, one or more of the roller carriages 38 may include one or more adjustable clamping mechanisms 47 within, as previously disclosed in US Patent Application Publication No. 2022/0299159 A1, which may apply adjustable pressure of a friction pad against the vertical rails 32 to slow the movement or be fully engaged to temporarily lock the carriage assemblies 38 and supported device or equipment at any position along the vertical rails.

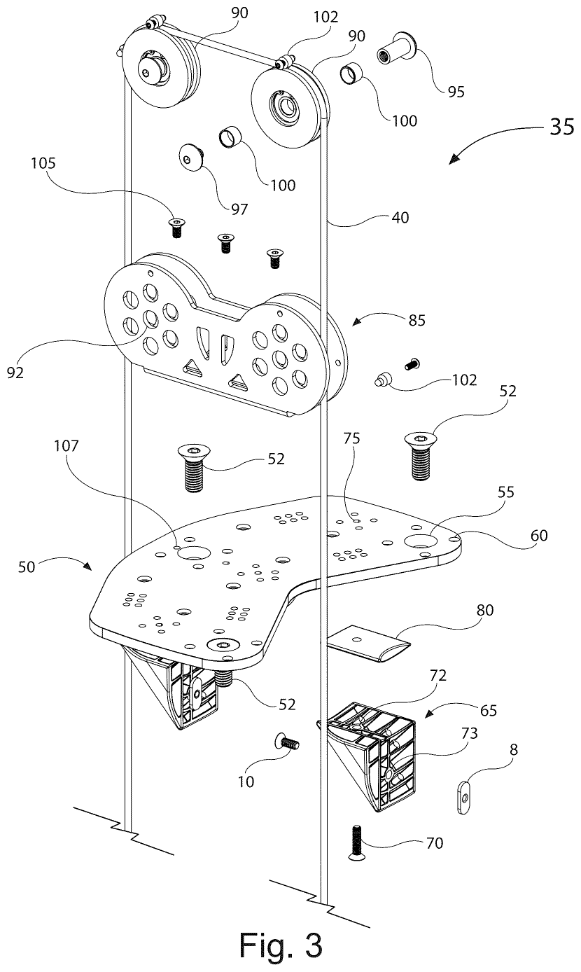

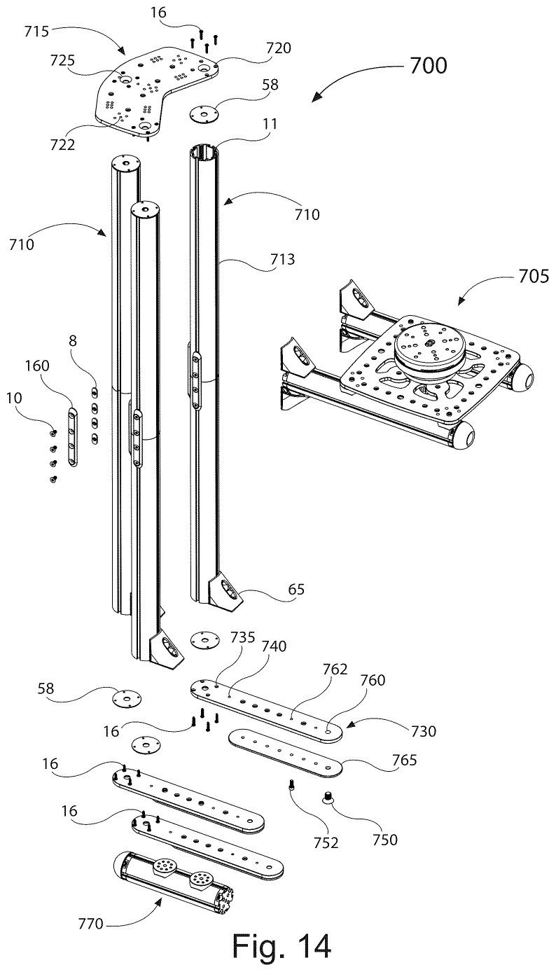

According to one embodiment, as shown in exploded view in FIG. 3, a pulley assembly 35 may comprise a mounting plate 50 whereby the assembly is demountably engaged with the top of the vertical rails 32. As shown, the threaded portion of screws 52 pass through holes 55 in the mounting plate 50 and are there threadedly engaged with a central threaded hole 53 in the threaded end connector 14 shown in FIG. 2 at the end of the vertical rail assemblies 32. According to a further embodiment, the vertical rails may exclude the threaded end connector and instead a mounting plate 50 attached directly or via a washer component 58 by screws 16 through holes 60 threadedly engaged with the screw slots 11, as will be described in further detail below with reference to FIG. 14. Optionally, the vertical rails 32 can be reinforced against the mounting plate 50 by corner brace connectors 65 fastened by a threaded portion of a screw 70 passed through a first through-hole 72 to be threadedly engaged with a threaded hole 75 in the mounting plate 50 via a flat insert 80 to adapt the corresponding concave side of the corner brace to the flat bottom of the mounting plate, and the perpendicular concave face of the corner brace connector 65 fastened by a threaded portion of a screw 10 passed through a second through-hole 73 to be threadedly engaged with a nut 8 in the nut channel 5 of the cylindrical structural component 3 of the vertical rail 32.

Pulley assembly 35 may further comprise a pulley bracket 85 within which one or more pulleys 90 are mounted to translate the motion of the cable 40 between sides of the vertical track assembly 28. The pulleys 90 may be secured at pulley axle holes 92 by a fastener. According to one embodiment, a binding barrel 95 is passed through an axle hole, the pulley, the axle hole on the opposite side and there secured by a binding barrel screw 97. Spacers or bushings 100 may be inserted around the binding barrel between the pulleys 90 and the pulley bracket 85 to maintain the central alignment of the pulleys. Cable retainers 102 may also be fastened near the outer edges of the pulley bracket for preventing the cable 40 from disengaging from the pulleys and pulley bracket 85. The pulley bracket 85 is fastened to the top of the mounting plate 50 by screws 105 threadedly engaged with threaded holes 107 in the mounting plate.

As illustrated in FIG. 2, the two roller carriages 38 of the device mount assembly 30 are connected centrally by a bridge component 110 comprising a threaded hole 111 in its center whereby the cable 40 is attached via a carabiner and an eyebolt 112 threadedly engaged with the bridge component 110. The bridge component 110 may be fastened by screws 114 to threaded holes 115 in the sides of the roller carriage assemblies 38. Two tube modules 116 and a device mount plate 118 are demountably engaged on the sides of the roller carriages 38 perpendicular to the bridge component 110. According to one embodiment, an adjustable-level bowl/ball mount assembly 119 may be demountably engaged with the device mount plate 118 whereby a device such as a camera, lighting equipment, sound recording equipment, audio/visual equipment, sensor, robotic gimbal, robotic arm, power tool, or other equipment or interfacing mount component may be demountably engaged by screws at threaded holes 120, or other means of attachment.

According to one embodiment, the bowl/ball mount assembly 119 is fastened to the device mount plate 118 by screws 121 through holes in a bowl mount component 122 threadedly engaged with threaded holes 125 in the device mount plate. A ball adapter 126 is retained within the bowl mount component 122 by a screw or bolt 128 through the center of the ball adapter, a central hole in the bowl mount component 122, and there threadedly engaged with a locking handle 130 fastened against the rounded bottom surface of the bowl mount component at varying angles in tandem with the ball adapter 126 and supported device or equipment so that they may be levelled on the bowl mount component. According to further embodiments, as previously disclosed in US Patent Application Publication No. 2022/0299159 A1, a bowl/ball mount assembly may comprise a mount screw extending from the center of the top surface of the assembly whereby a device, equipment, or interfacing mount component comprising a threaded hole in its bottom surface may be threadedly engaged.

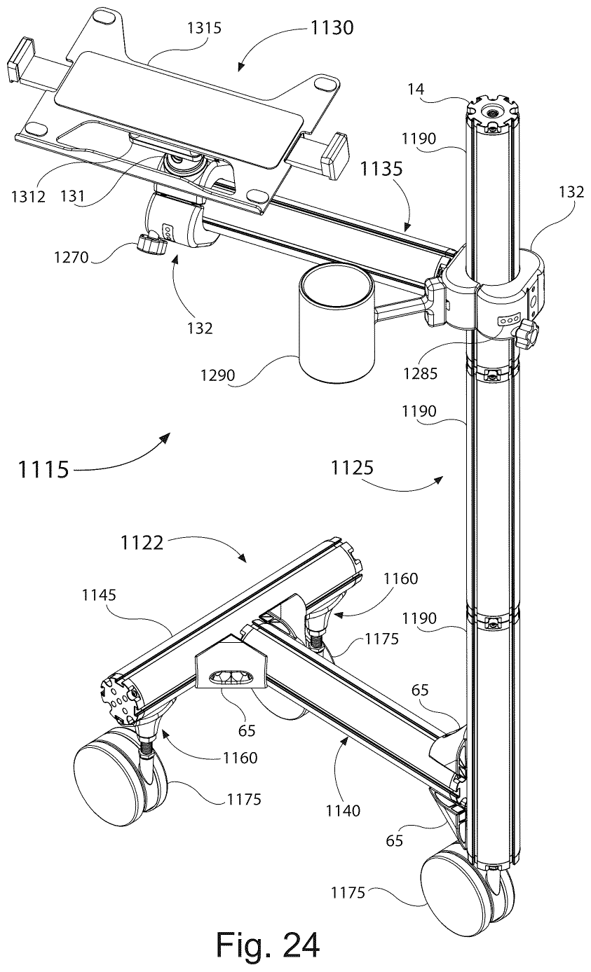

According to further embodiments, in place of a bowl/ball mount assembly, alternatively a device such as a camera, lighting equipment, sound recording equipment, audio/visual equipment, sensor, robotic gimbal, robotic arm, power tool, or other equipment may be demountably engaged on the device mount plate 118 or on a tube module 116 by another interfacing mount component such as a fluid-head mount, or a ball-and-socket joint mount 131 as shown in FIGS. 24, 25, and 27 which will be described in further detail below, or a stud mount component as previously disclosed in US Patent Application Publication No. 2022/0299159 A1, or a dovetail plate mount component as previously disclosed in US Patent Application Publication No. 2022/0299159 A1. A device, equipment, or interfacing mount component may alternatively be demountably engaged on a tube module via a clamp assembly 132 as shown in FIGS. 24 to 27 which will be described in further detail below.

According to one embodiment, each tube module 116 is demountably engaged with the roller carriages 38 by two corner brace connectors 65 fastened on one side to the outward faces of the roller carriages by screws 10 threadedly engaged with threaded holes in the roller carriages, and the perpendicular side with a side of the tube modules 116 by a screw 10 threadedly engaged with a nut 8 secured within a nut channel 134 in the sides of the modules' cylindrical structural component 135.

According to one embodiment, the four corners of the device mount plate 118 may be demountably engaged with either the top side or the bottom side of the tube modules 116 via four concave base components 136. The threaded portion of screws 138 are passed through holes in the corners of the device mount plate 118, and through-holes in the center of the concave base components 136, to be threadedly engaged with nuts 8 secured within the nut channels 134. Optionally, a bumper component 140 may be demountably engaged with the outer ends of the tube modules 116 by a screw threadedly engaged with the threaded hole 53 in the center of the modules' threaded end connectors 14. An operator may use one or both of the tube modules 116 as a handle to operate the rolling movement of the device mount assembly 30 along the vertical rail assemblies 32.

Alternatively, an operator may move the device mount assembly 30 by moving the counterweight carriage assembly 42 which is attached at the opposite end of the cable 40 via a carabiner and eyebolt 142 threadedly engaged with a threaded hole in the assembly's roller carriage 38. The counterweight carriage assembly 42 may further comprise a tube module 144 whereon are demountably engaged weight components 45 by one or more screws 146 passed through holes in the weight components and threadedly engaged with one or more nuts 8 in the nut channel of the tube module. For ease of handling and as a protective enclosure of the tube module 144, a soft end component 148 may be fastened by screws 16 to the ends of the tube module's cylindrical structural component 150. Furthermore, bumper components 152 may be fastened to the soft end components 148. Optionally the weighted tube module 144 may be secured to the roller carriage by an additional intermediate tube module and corner brace connectors 65, or as shown in FIG. 2, via a parallel gooseneck connector 154 fastened to the tube module 144 by screws and nuts, and fastened to the roller carriage 38 by screws in to threaded holes in the outward face of the roller carriage.

According to some embodiments, a roller carriage 38 may comprise a channel-guide component, as previously disclosed in US Patent Application Publication No. 2022/0299159 A1, which is secured to the interior rail-facing side of the roller carriage and is aligned with and inserted into the corresponding nut channel in the side of the vertical rail assembly's cylindrical structural component(s) 3, to prevent the counterweighted roller carriage 42 assembly from deviating off-line when traveling along the vertical rail assembly 32. The roller carriage 38 may additionally comprise one or more of an adjustable clamping mechanism 47, as previously disclosed in US Patent Application Publication No. 2022/0299159 A1, which can be adjusted to apply varying degrees of clamping force on the rail for intermittent stoppage or limitation of speed with partial pressure of the mechanism applied. An adjustable clamping mechanism 47 may also be adjusted to be fully disengaged so that the roller carriage 38 is moveable along the rail assembly 32 without resistance.

Vertical rail assemblies 32 may comprise a single elongate cylindrical structural component or according to some embodiments is configured to be extended or shortened by comprising two or more cylindrical structural components which can be added or removed, as is illustrated in FIG. 2. The two or more cylindrical structural components 3 may be conjoined end to end by channel braces 156 secured in the nut channels 5 by set screws 158. The channel braces 156 comprise an elongate plate element having an outer profile shaped for fitting and sliding within the nut channels 5 of the corresponding cylindrical structural components 3 wherein it may brace the two components together by threadedly engaging two or more set screws 158 in two or more threaded holes in the channel brace. The set screws 158 extend through the channel brace 156 to press against the bottom of the nut channels 5 which drives the brace outward to press against the inward top faces of the nut channels thereby securely engaging the cylindrical structural components 3 together.

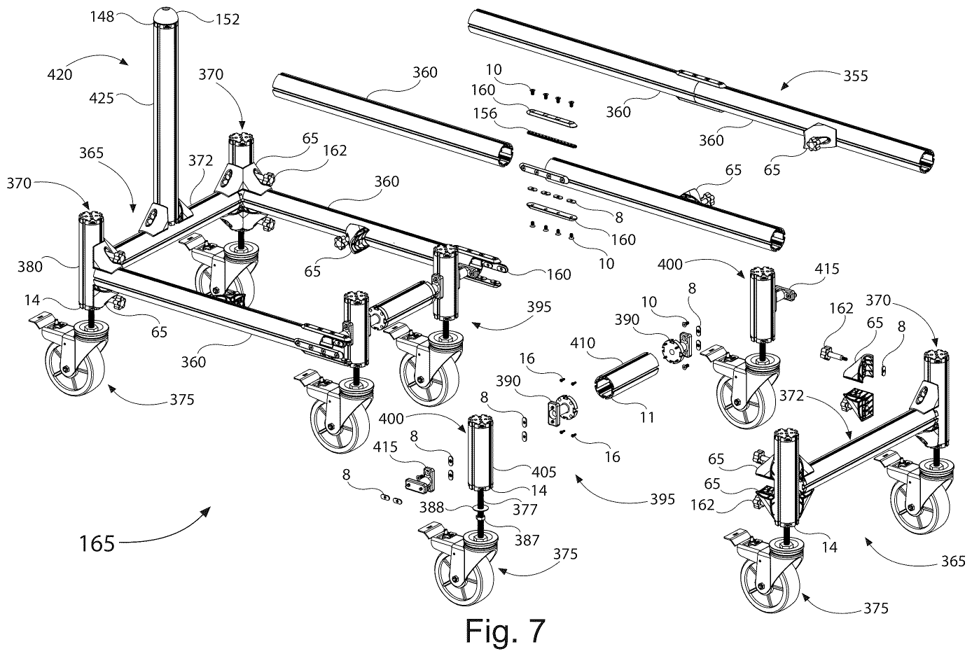

A series of two or more cylindrical structural components 3 may also be conjoined by one or more cylinder external braces 160 comprising two or more through-holes and a concave face whereby it may be demountably engaged against the sides of the two cylindrical structural components 3 by screws 10 with nuts 8 in the nut channels, or in place of the nuts used in conjunction with a channel brace 156 by engaging the screws 10 with threaded holes in the channel brace, as shown in FIG. 2 or in FIG. 7 in a horizontal rail assembly as will be described in further detail below. Vertical rail assemblies 32 may also include corner brace connectors 65 slidingly engaged by a nut 8 in a nut channel providing a track stopper element which can be repositioned along the rails, by fastening and unfastening a screw 10 or a threaded knob 162 for ease-of-use.

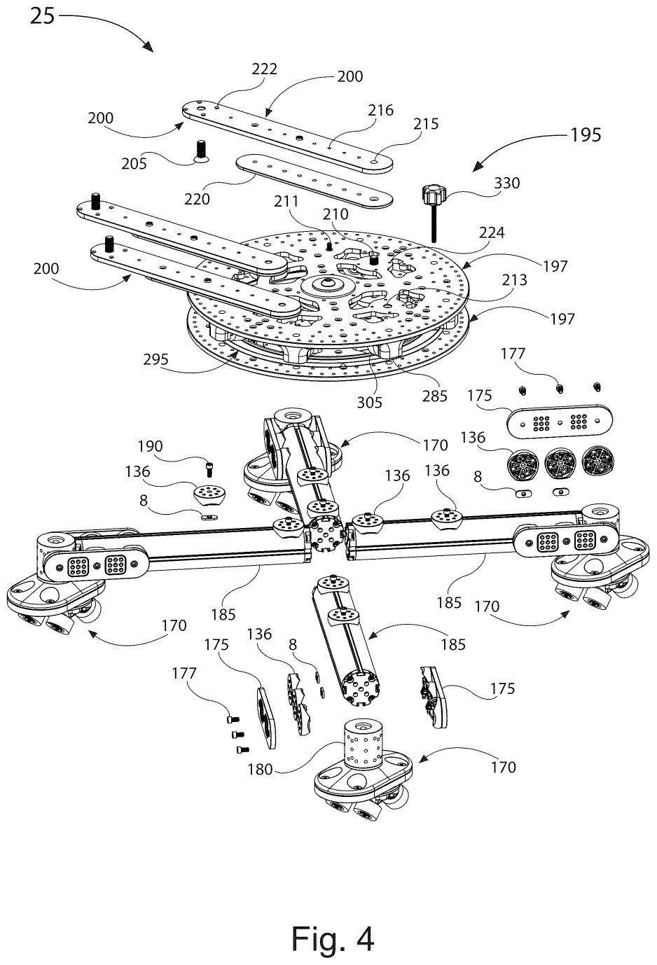

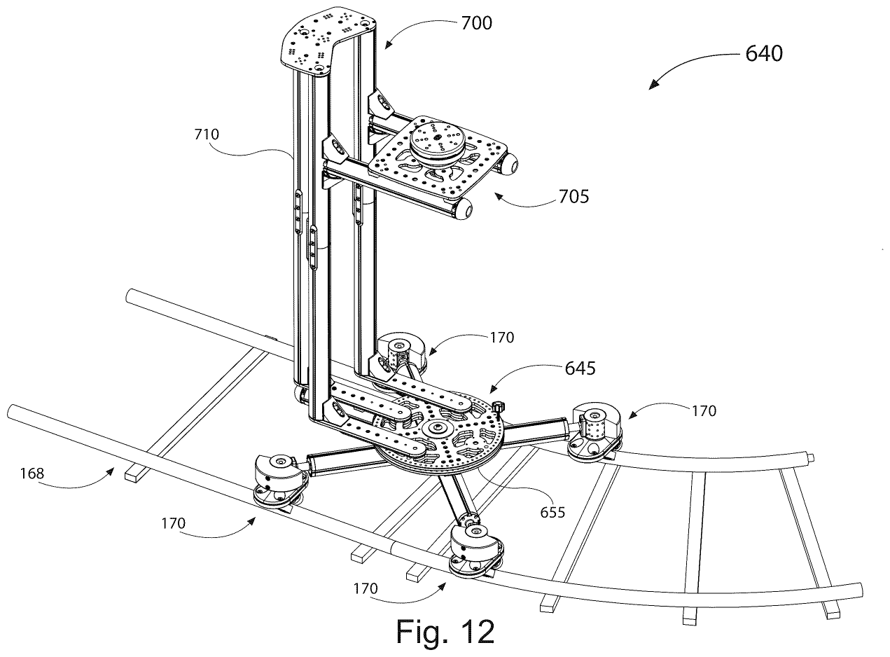

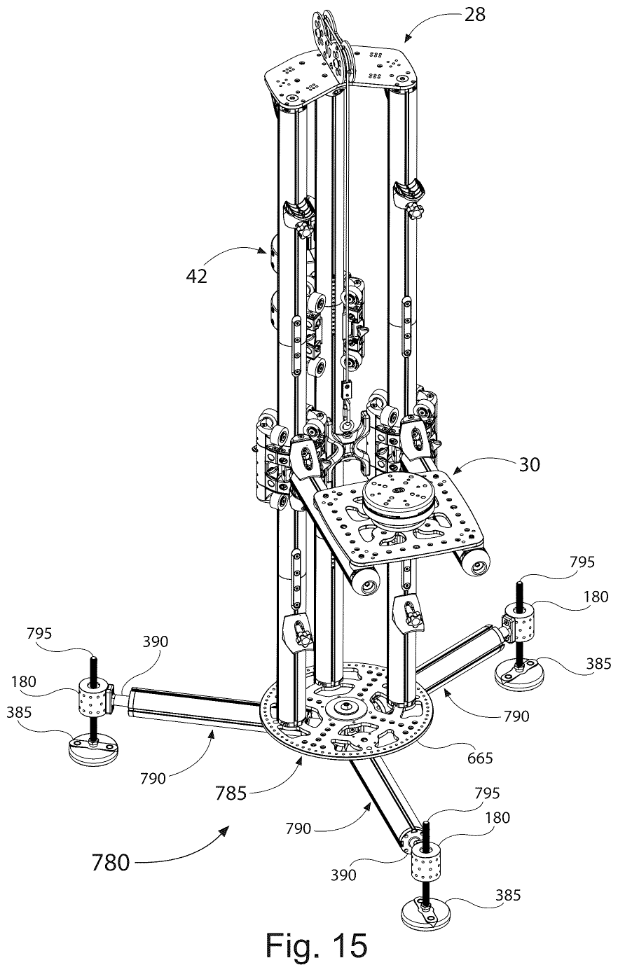

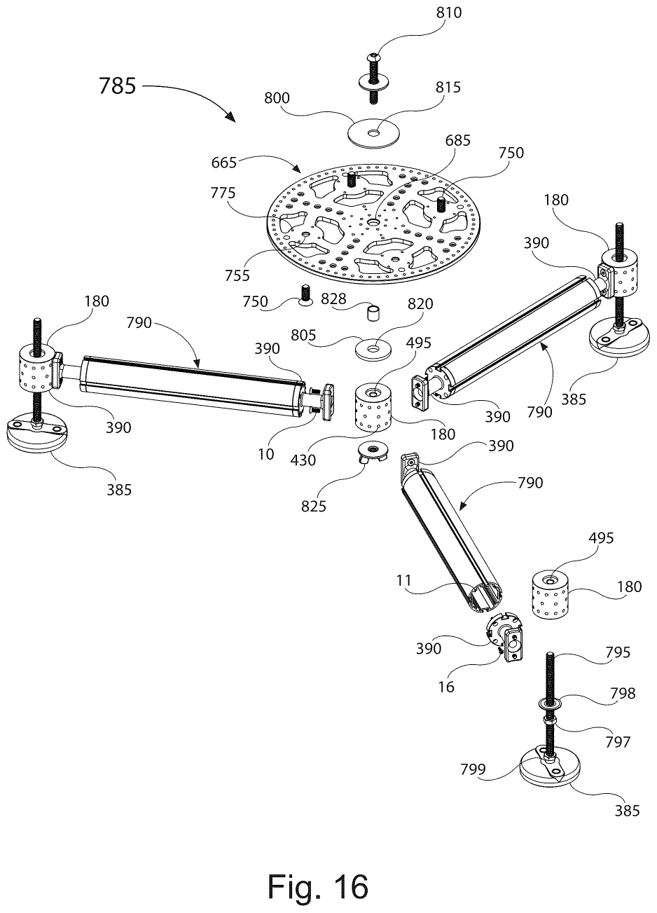

As illustrated in FIG. 1, a vertical track dolly 22 may further comprise a turntable dolly base 25 whereby the vertical track assembly 28 may be demountably engaged allowing for the 360-degree rotation of the vertical track assembly relative to the lower elements of the turntable dolly base. A turntable dolly base may be configured with casters for rolling directly on the ground or configured as a stand with foot components, as will be described in further detail below in reference to FIGS. 15 and 16. As shown in FIG. 1 and FIG. 4, the turntable dolly base 28 is configured for rolling movement along an adjustable-level track assembly 165, and the same components may be adjusted for rolling movement along a standard straight or curved track assembly 168 which will be described in further detail below in reference to FIG. 12.

According to one embodiment, the turntable dolly base 25 comprises four cylindrical track roller modules 170 attached via brace plates 175 and concave base components 136 engaged by screws 177 with threaded holes 178 in the sides of the track roller modules' cylindrical mount components 180 and with nuts 8 in the nut channels of the tube modules 185. Demountably engaged centrally at the four inward portions of the tube modules 185 by screws 190 concave base components 136, and nuts 8, is a lockable turntable assembly 195 comprising two rotation plates 197. A threaded portion of screws 190 are passed downwardly through holes 198 in the lower rotation plate 197 and through the hole in the center of the concave base components 136 to secure the assembly against the tube modules 185 by threadedly engaging the screws with the nuts in the nut channels of the tube modules.

According to one embodiment, as shown in FIG. 1, the 3-rail vertical track assembly 28 is upwardly engaged on the lockable turntable assembly 195 via three turntable extension plates 200 by screws 205 threadedly engaged with the threaded hole 53 in the center of the threaded end components 14 at the bottom ends of the three vertical rail assemblies 32. The turntable extension plates 200 are fastened by upward screws 210/211 through holes 213/214 in the top rotation plate 197 and threadedly engaged with threaded holes 215/216 in the extension plates 200. A washer plate 220 comprising through-holes may be inserted between the top rotation plate 197 and the extension plates 200 to stiffen the assembly. Optionally, for additional reinforcement a tube module 221, as shown in FIG. 2 where extending beyond the rotation plates 197, may be demountably engaged by screws, concave base components, and nuts to the underside of one or more of the extension plates 200 or washer plates 220.

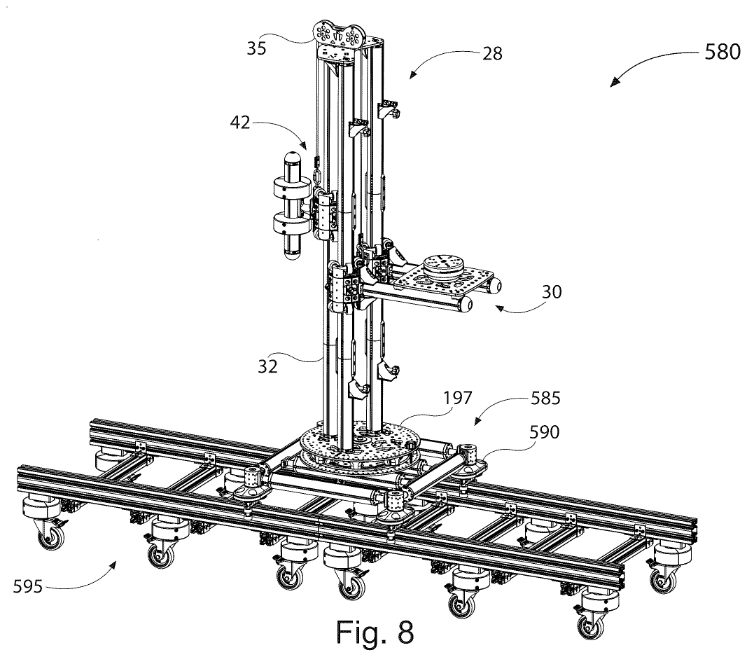

The turntable extension plates 200 may be provided to offset the vertical rail assembly 28 to effectively center the device mount plate 130 and supported device or equipment directly above the rotational axis of the lockable turntable assembly 195 when preferred by the operator. Alternatively, the bottom ends of the vertical track assembly's three vertical rails 32 may be mounted directly to the top rotation plate 197 by screws 210 through holes 213 there threadedly engaged with the central threaded hole 53 in the threaded end connectors 14 at the bottom ends of the three vertical rails 32, as will be described in further detail below in reference to FIG. 8. According to further embodiments, the vertical rails may exclude the threaded end connectors and instead their cylindrical structural components fastened to the extension plates 200 directly or via a washer component 58, as shown in FIG. 14, by screws 16 through holes 222 and into the screw slots 11, or fastened to the top rotation plate 197 directly or via the washer component 58, by screws 16 through holes 224.

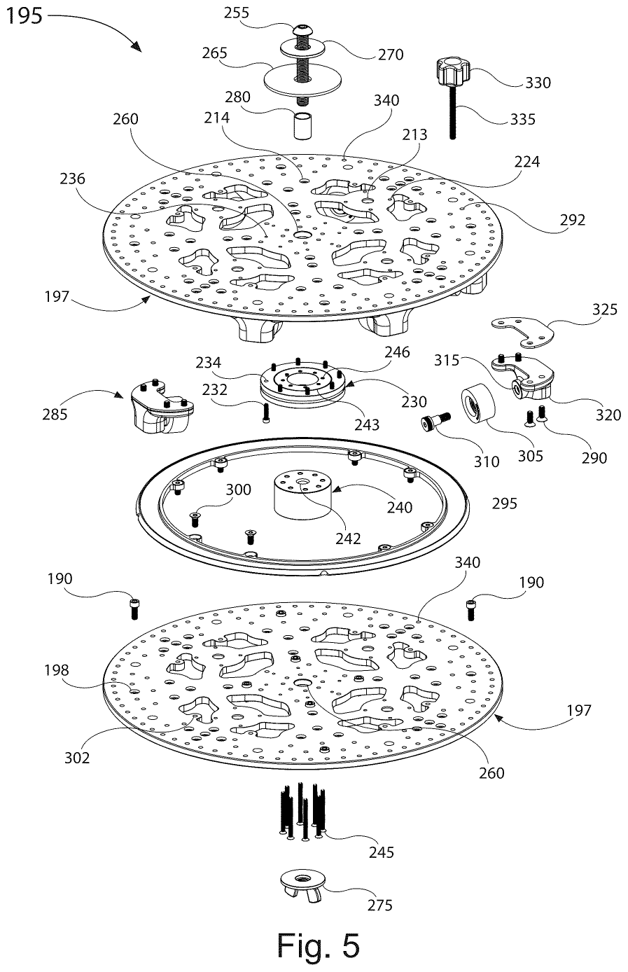

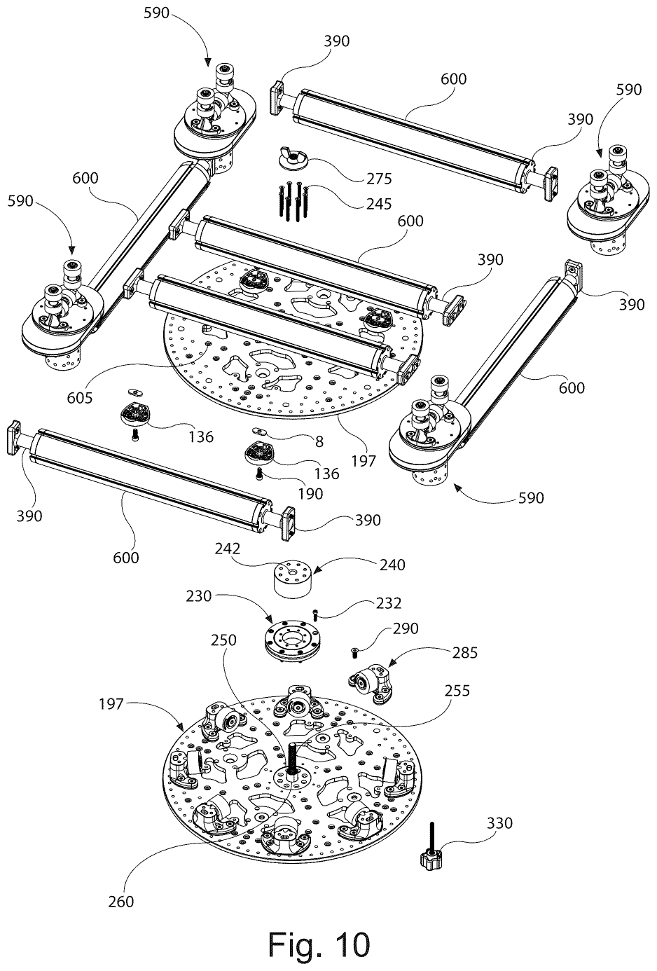

According to one embodiment as illustrated in FIG. 5, a lockable turntable assembly 195 comprises a rotational bearing 230 mounted centrally between the top and bottom rotation plates 197 allowing the top plate to rotate 360 degrees relative to the bottom plate. The rotational bearing 230 is fastened by screws 232 through holes in its outer ring 234 and there threadedly engaged with threaded holes 236 in the top rotation plate 197. A bearing retainer 240 with a central threaded hole 242 is mounted between the inner ring 243 of the bearing 230 and the bottom rotation plate 197, there fastened by screws 245 through the bottom plate and through holes in the bearing retainer 240 and threadedly engaged with threaded holes 246 in the inner ring 243 of the bearing. As indicated on the bottom view of the lockable turntable assembly 195 shown in FIG. 10 which will be described in further detail below, the rotation plates 197 further comprise a circular recess 250 which matches the diameter of the inner ring 243 of the bearing 230 so that the inner ring does not make contact with the underside of the top rotation plate 197, therefore allowing the outer ring, while fastened to the top plate, to rotate around the inner ring.

Optionally the lockable turntable assembly 195 may comprise a tension screw or bolt 255 of which a threaded portion is passed through a through-hole 260 in the center of the top rotation plate 197 and through the inner ring 243 of the bearing 230 and there threadedly engaged with the central threaded hole 242 in the bearing retainer 240. A rotation disc 265 made of a low-friction material may be installed between the head of the tension screw/bolt 255 and the top of the rotation plate 197. A washer 270 may also be included between the head of the screw/bolt 255 and the rotation disc 265. Tightening the tension screw/bolt 255 to a medium setting slows rotation of the top rotation plate 197 against the rotation disc 265, or at full tension locks rotation. A lock-nut 275 may also be provided under the bottom rotation plate 197, and the screw/bolt 255 threaded through the bearing retainer 240 to pass through the center through-hole 260 in the bottom rotation plate where the lock-nut 275 can be engaged onto the screw/bolt and against the bottom of the plate. A bushing 280 may also be optionally installed through the center through-hole 260 of the top rotation plate 197 to maintain the central alignment of the rotation disc 265.

According to some embodiments, for added stability around the rotation of the bearing 230, or optionally excluding the bearing and used as the rotation element alone, a lockable turntable assembly 195 may further comprise three or more roller elements 285 which may be fastened to the underside of the top rotation plate 197 by screws 290 threadedly engaged with threaded holes 292 in the top rotation plate, and are configured to roll in a circular path along a circular roller track inlay 295 which may be fastened to the topside of the bottom rotation plate by screws 300 threadedly engaged with threaded holes 302 in the bottom rotation plate. The roller element 285 may comprise a roller 305 rotationally engaged on an axle screw 310 which is threadedly engaged with a threaded hole 315 in a roller mount 320 which is fastened to the top rotation plate 197 by the screws 290. For reduction of noise and vibration, a non-metallic insert 325 may be included between the roller mount and the rotation plate. According to one embodiment, as illustrated, a lockable turntable assembly comprises eight roller elements. According to another embodiment, a lockable turntable assembly comprises four roller elements. According to further embodiments, a lockable turntable assembly comprises any number between three and 24 roller elements.

A lockable turntable assembly 195 may further comprise a threaded locking knob 330 with a threaded stem 335 which may provide a locking function in addition to or instead of the tension screw/bolt 255. The threaded stem 335 is threadedly engaged with one of a plurality of threaded holes 340 located radially at given increments around the two rotation plates 197. To lock rotation of the turntable assembly 195, the locking knob 330 is rotated to extend the threaded stem 335 down from the threaded hole 340 in the top plate to be threadedly engaged with a corresponding threaded hole 340 in the bottom plate 197. To unlock rotation, the locking knob is rotated in the opposite direction to retract the threaded stem 335 from the threaded hole in the bottom plate 197 to therefore allow rotation of the top plate 197, bearing 230, and supported vertical rail assembly or vertical adjustment assembly. According to one embodiment, the rotation plates 197 may comprise seventy-two threaded holes 340 to allow the plates to be locked relative to each other at 5-degree increments. According to further embodiments, rotation plates may comprise any number between four and one-hundred-eighty threaded holes.

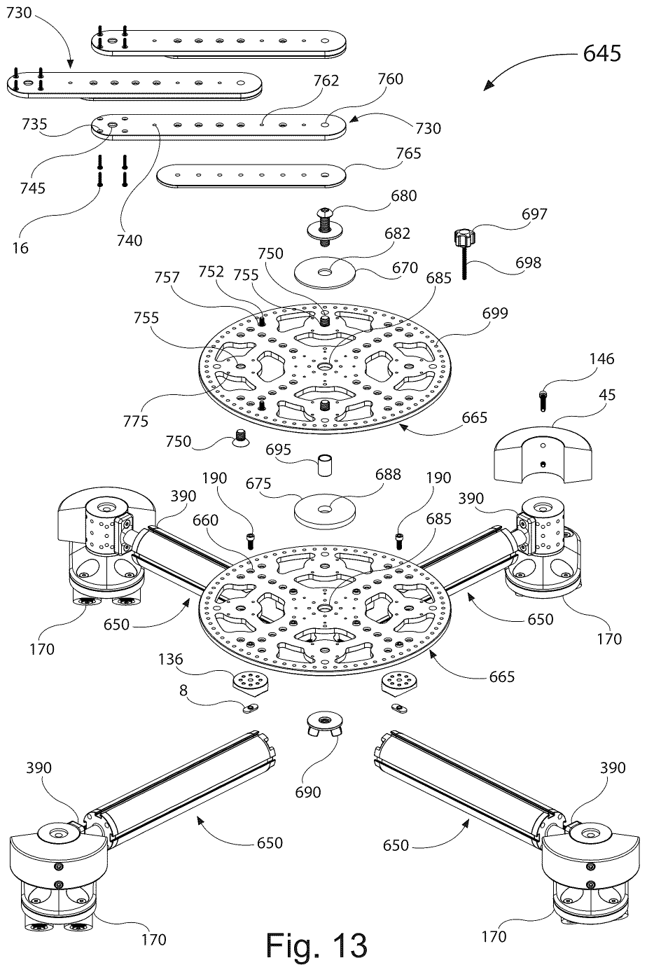

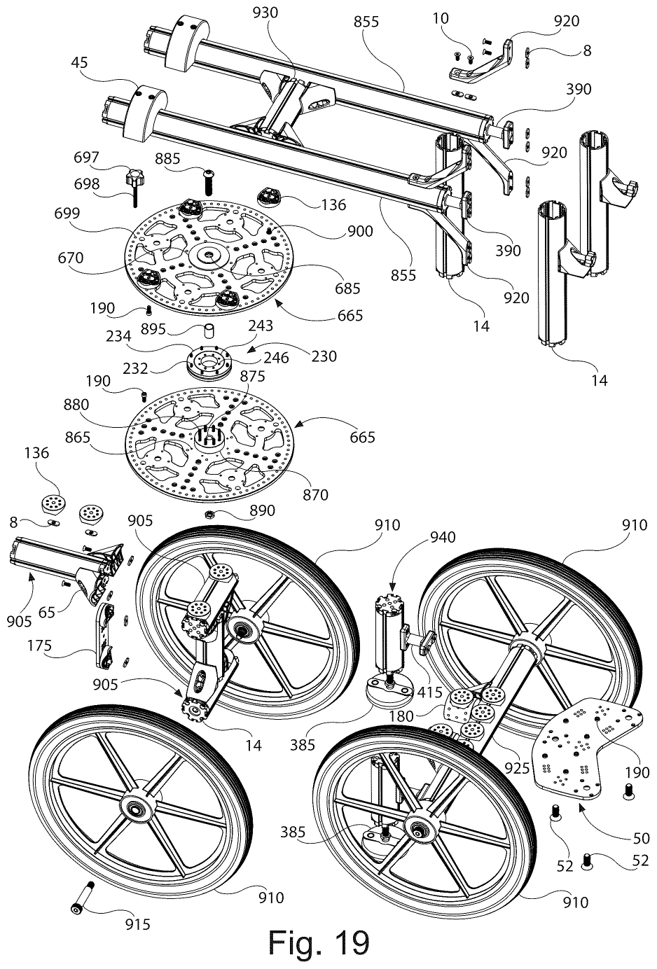

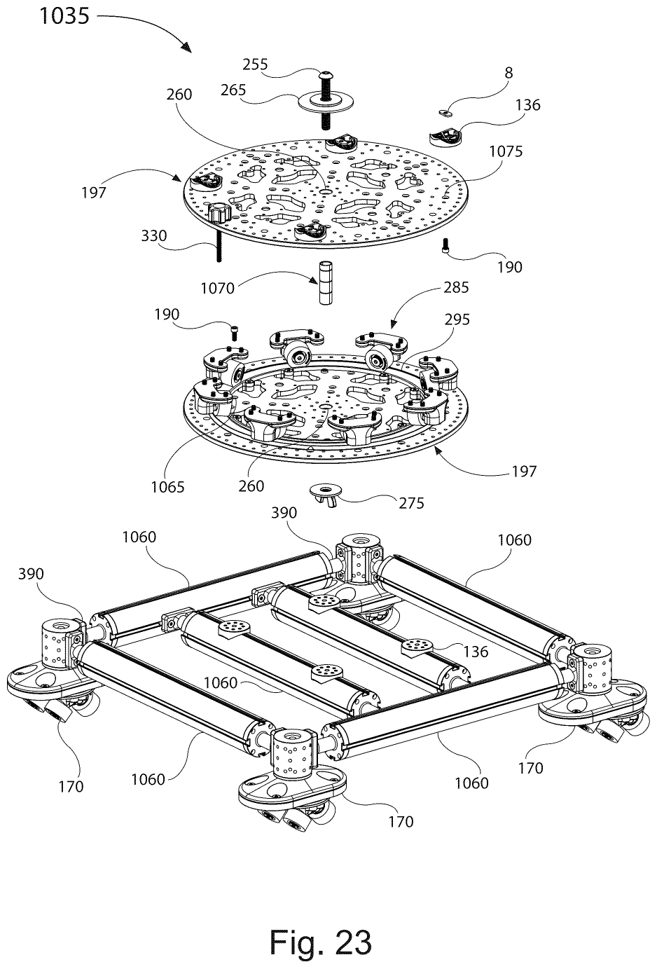

According to further embodiments, in place of the lockable turntable assembly 195, the rotational function of a vertical track dolly 22 may be provided by the lockable turntable assembly in FIG. 13 as will be described below where rotatable on a low-friction disc, or provided by the lockable turntable assembly in FIG. 19 as will be described below where rotatable on the bearing 230 alone without the roller elements 285, or provided by the lockable turntable assembly in FIG. 23 as will be described below where rotatable by only the roller elements 285.

As illustrated in FIG. 1, a track dolly may be configured for rolling movement along an adjustable-level track assembly. The base of the vertical track dolly 22 is configured as the turntable dolly base 25 with four cylindrical track roller modules 170 which travel stably along an adjustable-level track assembly 165. According to one embodiment, as shown in exploded view in FIG. 7, the adjustable-level track assembly 165 comprises two parallel horizontal rail assemblies 355 with cylindrical structural components 360 forming the rails. Each horizontal rail assembly 355 may comprise a single elongate cylindrical structural component 360 or according to some embodiments is configured to be extended or shortened by comprising two or more cylindrical structural components 360 which can be added or removed, as is illustrated in FIG. 7.

The two or more cylindrical structural components 360 may be conjoined end to end, as previously described in reference to FIG. 2, by channel braces 156 secured in the nut channels by set screws 158. A series of two or more cylindrical structural components 360 may also be conjoined by one or more cylinder external braces 160 comprising two or more through-holes and a concave face whereby it may be demountably engaged against the sides of the two corresponding cylindrical structural components 360 by screws 10 with nuts 8 in the nut channels, or in place of the nuts used in conjunction with a channel brace 156 by engaging the screws 10 with threaded holes in the channel brace 156. Horizontal rail assemblies 355 may also include corner brace connectors 65 slidingly engaged by a nut 8 in one of the nut channels to provide a track stopper element which can be repositioned along the rails, by fastening and unfastening a screw 10 or a threaded knob 162 for ease-of-use.

The horizontal rail assemblies 355 may be supported at each end by a height-adjustable track end assembly 365 demountably engaged at the ends of the rail assemblies by two corner brace connectors 65 secured laterally to the nut channels on the top and bottom of the rails and secured vertically to two vertical post tube modules 370 at the ends of a central tube module 372 secured to the center-facing nut channels of the vertical post tube modules 370 by two corner brace connectors 65. At the bottom of each vertical post tube module 370 is a threaded end connector 14 whereby a long threaded-stem caster 375 is threadedly engaged by its threaded stem 377 and can be extended or retracted into the cylindrical structural component 380 of the modules 370 to raise or lower its corner of the track assembly 165. In combination with adjustment of the casters 375 on the other vertical post modules 370, the track assembly can be raised and lowered and levelled. According to further embodiments, the casters 375 may be replaced by long threaded-stem foot components 385 as will be described in further detail below with reference to FIGS. 15 and 16. The casters 375 or the foot components 385 may include a lock-nut 387 and a washer 388 on the threaded stem 377 which may be used to lock the stem position to prevent unwanted rotation of the components during operation.

In addition to height-adjustment and levelling provided by the threaded-stem casters 375, the ends of the horizontal rail assemblies 355 can be raised and lowered along the vertical post modules 370 by loosening the screws or threaded knobs 162 of the corner brace connectors 65 where engaged with nuts 8 in the nut channels of the vertical cylindrical structural components 380 and repositioning the connectors 65 and retightening the screws or threaded knobs at the new vertical position along the modules 370. According to further embodiments, the two corner brace connectors 65 at each end of the rails can be replaced by a cylinder gooseneck end connector 390, as will be described in further detail below.

According to some embodiments and as shown in FIG. 7, the horizontal rail assemblies 355 may be additionally supported by one or more of a height-adjustable cross-support assembly 395 comprising two vertical post tube modules 400 each having at the bottom a threaded end connector 14 whereby a long threaded-stem caster 375 may be threadedly engaged and can be extended or retracted into the cylindrical structural components 405 of the tube modules to raise or lower them as additional points of contact with the ground for support and levelling and height-adjustment of the track assembly.

According to further embodiments, the casters 375 may again be replaced by the long threaded-stem foot components 385 shown in FIGS. 15 and 16.

A short horizontal cylindrical structural component 410, having at each end a cylinder gooseneck end component 390 secured by screws 16 to the component's screw slots 11, bridges the two vertical post modules 400. According to one embodiment, the two horizontal rail assemblies 355 are demountably engaged to the vertical post modules 400 by an inwardly mounted perpendicular gooseneck connector 415 secured by screws 10 and nuts 8 in the nut channels of the corresponding cylindrical structural components 360/405. The perpendicular gooseneck connectors 415 have a low profile and space the vertical post modules away from the horizontal rails such that they remain passable by the track roller modules 170. In addition to height-adjustment and levelling which may be provided by the threaded-stem casters 375 or threaded-stem foot components 385, each end of the cross-support assembly 395 may also be raised and lowered at one or both ends by loosening the screws of the perpendicular gooseneck connectors 415, where engaged with nuts 8 in the channels of the vertical cylindrical structural components 405, and then repositioning the connectors 415 and retightening the screws at the new vertical position along the vertical post modules.

For ease of mobility of the adjustable-level track assembly 165, one or more push handle assemblies 420 may be demountably engaged with one or both of the track end assemblies 365. According to one embodiment, the push handle assembly 420 comprises a tube module 425 demountably engaged by two corner brace connectors 65 to a central tube module 372 of one of the track end assemblies 365. The push handle assembly may further comprise a soft threaded end component 148 and bumper component 152 for handling at the top end of the module 425. According to a further embodiment, the two corner braces 65 may be replaced by a cylinder gooseneck end component 390 for demountable engagement of the push handle assembly 420 to the central tube module 372.

As previously noted, the turntable dolly base 25 is configured to stably roll along the adjustable-level track assembly 165 on four cylindrical track roller modules 170 demountably engaged at the ends of the tube modules 185 there secured by brace plates 175 and concave base components 136 engaged by screws 177 threadedly engaged with threaded holes 178 in the sides of the track roller modules' cylindrical mount components 180. According to a further embodiment, track roller modules 170 may be secured to the end of a cylindrical structural component via a cylinder gooseneck end connector 390 by screws threadedly engaged with threaded holes 430 in the cylindrical mount component 180, as will be described in further detail below in reference to FIGS. 12 and 13.

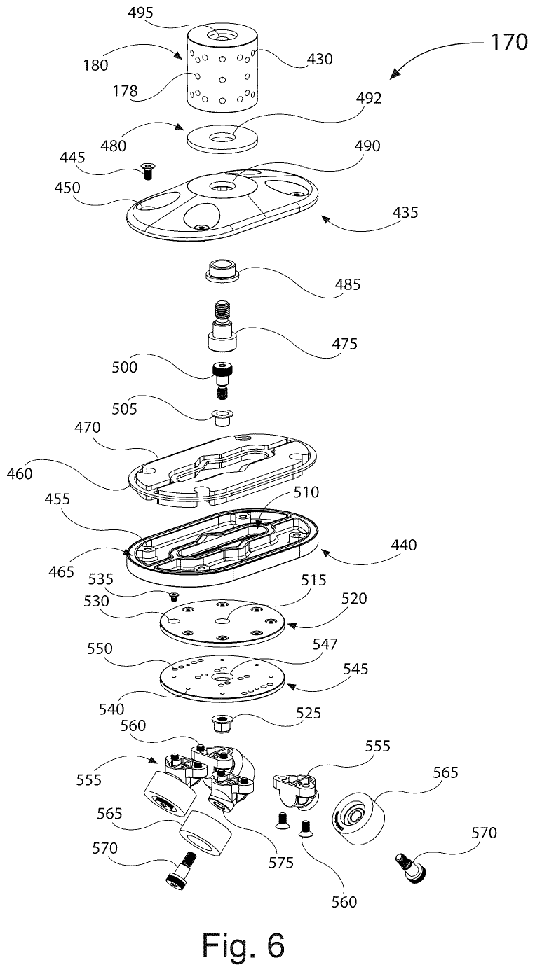

According to one embodiment, as illustrated in FIG. 6, a cylindrical track roller module 170 further comprises an upper body component 435 and a lower body component 440 which are secured to one another by screws 445 through holes 450 in the upper body component and threadedly engaged with threaded holes 455 in the lower body component. For operational noise and vibration reduction, a foam or rubber gasket component 460 may be included in a recess 465 between the contact areas of the upper and lower body components, and foam or rubber inserts 470 may be included in the hollow areas of the body components.

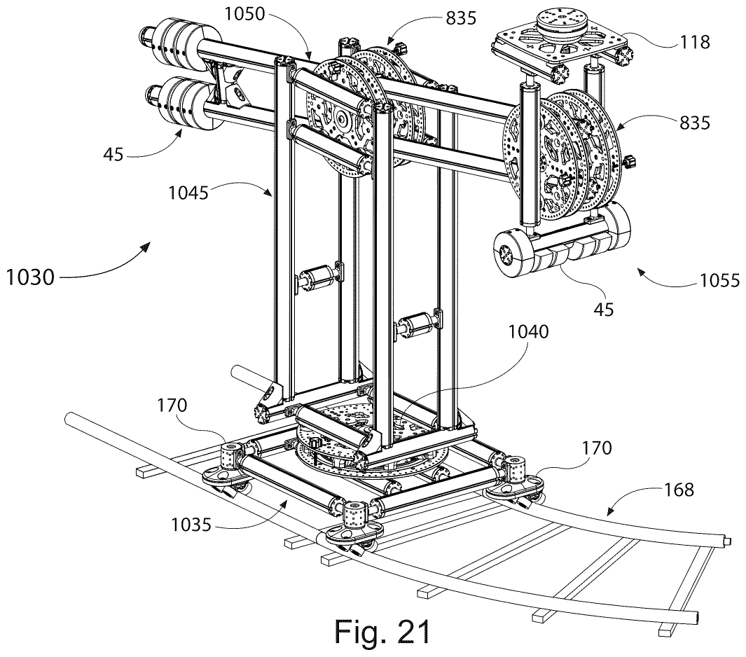

The upper body component 435 is secured by an upper pivot shoulder screw 475 to the cylindrical mount component 180 via a low-friction upper pivot disc 480 between the two components which allows them to pivot 360 degrees relative to one another where required for rolling movement along a curved rail or curved track assembly 168 as will be described in further detail below in reference to FIG. 12 and FIG. 21. An upper bushing 485 is installed on the shoulder of the shoulder screw 475 and the two components are situated in a recessed interior of the upper body component 435 and in a through-hole 490 in its center from which the threaded portion of the shoulder screw passes through a through-hole 492 in the pivot disc 480 and is threadedly engaged with a threaded hole 495 through the center of the cylindrical mount component 180. At an appropriate tension of the shoulder screw 475, the parts are retained while allowing rotation of the cylindrical mount component 180 rotating against the upper pivot disc 480 and the upper shoulder screw 475 rotating within the upper bushing 485.

The track roller module 170 further comprises a lower pivot shoulder screw 500 which is pivotably retained in a lower bushing 505 which is slidingly and pivotably retained within an elongate slot 510 which runs through a center portion of the lower body component 440. The threaded portion of the lower pivot shoulder screw 500 there extends from the bottom of the body component and through a through-hole 515 in the center of a low-friction lower pivot disc 520 and there secured by a lock-nut 525 which is threadedly engaged with the shoulder screw and fastened against the bottom of the disc 520. The lower pivot disc 520 further comprises through-holes 530 with recesses on the top side for fully containing the heads of screws 535 of which the threaded portions extend from the bottom of the lower pivot disc and are threadedly engaged with threaded holes 540 in a roller mount plate 545 which further comprises a lock-nut hole 547 greater than the diameter of the lock-nut 525 so that the two components do not interfere with each where located against the bottom of the lower pivot disc 520. The roller mount plate 545 may also include a plurality of sets of track diameter-adjustment roller mount holes 550 at which at least two cylindrical track roller mounts 555 are fastened by screws 560 threadedly engaged with the roller mount holes 550. A roller 565 is rotationally engaged on an axle screw 570 which is threadedly engaged with a threaded hole 575 in the roller mounts 555. Where needing to be reconfigured for compatibility with differing diameters of cylindrical rails and track assemblies such as the adjustable-level track assembly 165 in FIGS. 1 and 7 or a curved track assembly 168 such as in FIGS. 12 and 21, the operator may unfasten the screws 560 and realign the roller mounts 555 at a different set of the holes 550 and refasten the screws for the modules 170 to be reconfigured for the alternative separation provided between the corresponding rollers.

Where operating on a curved rail or curved track assembly 168, the combination of the pivoting movement of the upper body component assembly with the pivoting and sliding movement of the lower body component assembly at the contact surface of the lower bushing 505 within the slot 510 and the top surface of the lower pivot disc 520 against the bottom surface of the lower body component 440, the track roller modules 170 are configured to smoothly traverse the curvatures and shifting alignments of the track roller modules on the curved rails.

According to further embodiments, a vertical track dolly or a height-adjustable dolly may be configured on track roller modules for rolling movement along square rails or track assemblies or rectangular rails or track assemblies. As illustrated in FIGS. 8 to 11, a vertical track dolly 580 comprising a turntable dolly base 585 is configured with four square track roller modules 590 for rolling movement along a rectangular rail track assembly 595 comprising two or a series of parallel rectangular rail segments supported by casters or foot components and cross-segments fastened to the rails by square brackets. The vertical track dolly 580 further comprises the 3-rail vertical track assembly 28, as previously described in reference to FIG. 2, demountably engaged directly to the top rotation plate 197 of the turntable dolly base 585, allowing for rotatable and vertical movement of the device mount assembly 30 and a supported device or equipment.

According to one embodiment, as shown in FIGS. 8 to 11, the turntable assembly of the turntable dolly base 585 is configured the same as the lockable turntable assembly 195, as previously described. According to one embodiment, as shown, the bottom ends of the vertical track assembly's three vertical rails 32 may be mounted directly to the top rotation plate 197 by screws 210 through holes 213 there threadedly engaged with the central threaded hole 53 in the threaded end connectors 14 at the bottom ends of the three vertical rails 32. Alternatively, as previously described in reference to FIG. 4, the vertical track assembly 28 may be demountably engaged via the turntable extension plates 200 to offset the vertical rail assembly to effectively center a supported device or equipment directly above the rotational axis of the turntable dolly base 585. According to further embodiments, the vertical rails 32 may exclude the threaded end connectors 14 and instead their cylindrical structural components fastened to the extension plates 200 directly or via a washer component 58, as shown in FIG. 14, or fastened to the top rotation plate 197 directly or via the washer component 58, by screws 16 through holes 224.

According to further embodiments, in place of the lockable turntable assembly 195, the rotational function of a vertical track dolly 580 may be provided by the lockable turntable assembly in FIG. 13 as will be described below in reference where rotatable on a low-friction disc, or provided by the lockable turntable assembly in FIG. 19 as will be described below where rotatable on the bearing 230 alone without the roller elements 285, or provided by the lockable turntable assembly in FIG. 23 as will be described below where rotatable by only the roller elements 285.

The turntable dolly base 585 further comprises, according to one embodiment, a base frame assembled of six cylindrical structural components 600, having at each end a cylinder gooseneck end component 390, as previously described, secured by screws to the component's screw slots. The four outer cylindrical structural components form the outer frame of the dolly base, at the corners of which the four square track roller modules 590 are demountably engaged with the cylinder gooseneck end components 390. The two inner cylindrical structural components 600 span the middle of the dolly base whereon the lockable turntable assembly 195 is demountably engaged at through-holes 605 by screws 190, concave base components 136, and nuts 8 threadedly engaged by the screws within the nut channels of the cylindrical structural components.

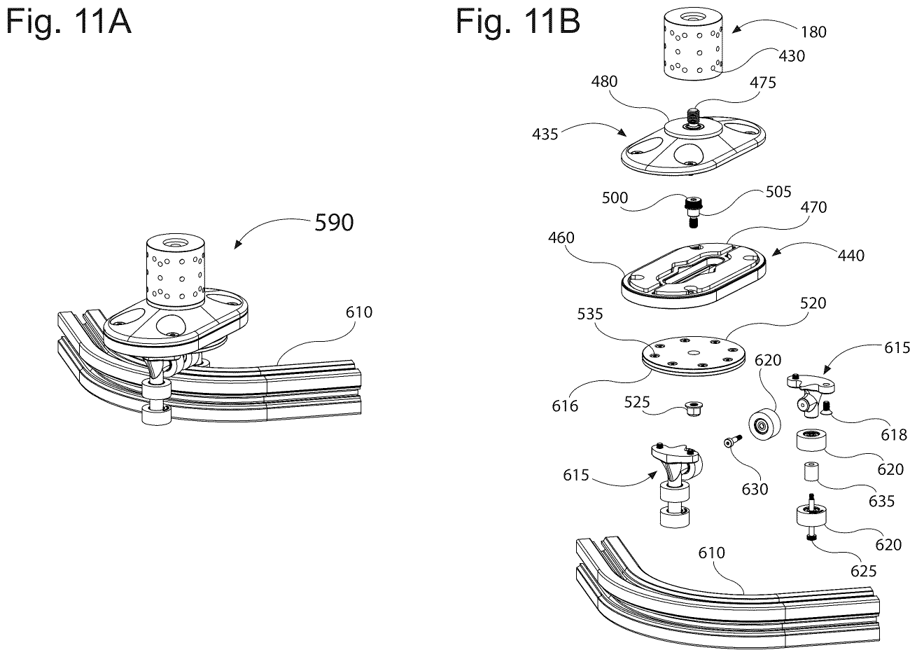

As previously noted, the square track roller modules 590 are specially configured for rolling movement along the rectangular rail track assembly 595 or other straight or curved square or rectangular rails or track assemblies such as a curved square rail component 610 as shown in FIG. 11. According to one embodiment, the square track roller modules 590 may comprise two square rail roller mounts 615 fastened to the bottom of a roller mount plate 616 by screws 618 threadedly engaged with threaded holes in the roller mount plate 616, which is upwardly mounted by the screws 535 to the lower pivot disc 520 and thereby the other components of the modular assembly as previously described in reference to FIG. 6. The square rail roller mounts 615 each comprise two rollers 620 attached downwardly by a vertical shoulder screw 625, in addition to one roller 620 attached inwardly by a horizontal shoulder screw 630. The two downward rollers 620 may be spaced for alignment and best contact with the sides of a straight or curved square rail component by a spacer 635 having a through-hole corresponding with the shoulder screw 625 and axle holes of the rollers 620. The square track roller modules 590 thereby maintain directional alignment atop one or an assembled series of square or rectangular rail components such as in the rectangular rail track assembly 595 in FIG. 8 or the curved square rail component 610.

As like the cylindrical track roller modules 170, the square track roller modules 590 comprise the cylindrical mount component 180 whereby the modules are demountably engaged to the cylinder gooseneck end components 390 at the corners of the dolly base frame by screws 10 threadedly engaged with threaded holes 430 in the cylindrical mount components. As noted above, the square track roller modules 590 also further comprise the previously described assembly of upper and lower body components 435/440, pivot discs 480/520, shoulder screws 475/500, and bushings 485/505 which together allow the square track roller modules 590 to pivot and slide for curvatures and shifting alignments of the modules where operating along curved rails.

According to further embodiments, an assortment of the modular support components may further be configured as a height-adjustable dolly for rolling and pivoting a supported device or equipment within a selectable range of height. As illustrated in FIGS. 12 to 14, a height-adjustable dolly 640 may comprise a turntable dolly base 645 with four tube modules 650 demountably engaged inwardly with the underside of a lockable turntable assembly 655, and outwardly with four cylindrical track roller modules 170 attached as previously described to four cylinder gooseneck end connectors 390 of the tube modules 650. According to further embodiments where operating without the need for a track assembly, a height-adjustable dolly 640 or turntable dolly base 645 may exclude the track roller modules and alternatively be moved about and positioned and levelled on casters 375 such as those shown in FIG. 7 or foot components 385 such as those shown in FIG. 15.

The cylindrical track roller modules 170 of the turntable dolly base 645 are configured for rolling movement along a track assembly with straight and curvilinear sections of cylindrical rails. The track roller modules 170 comprise the components as described in reference to FIG. 6 but in which here the roller mounts 555 have been positioned inwardly on the roller mount plate 545 to space the rollers 565 for proper contact along the narrower diameter rails of a curved track assembly 168. Optionally, for added balance and stability, weight components 45, as previously described in reference to FIG. 2, are demountably engaged by screws 146 threadedly engaged with threaded holes in the side of the roller modules' cylindrical mount components 180.

As illustrated in FIG. 13, the inward ends of the tube modules 650 are demountably engaged with the underside of the lockable turntable assembly 655 by screws 190 through holes 660 in the lower of two rotation plates 665 and through concave base components 136 and threadedly engaged with nuts 8 in the nut channels of the tube modules 650. The lockable turntable assembly 655 rotates 360 degrees without the use of the bearing 230 or roller elements 285 as previously described. According to this embodiment, the top rotation plate 665 is rotatable 360 degrees within an upper low-friction disc 670 against its top surface and a lower low-friction disc 675 below between it and the bottom rotation plate 665. A rotation tension screw or bolt 680 passes through a central through-hole 682 in the upper disc 670, a through-hole 685 in the center of the top rotation plate 665, a central through-hole 688 in the lower disc 675, the through-hole 685 in the center of the bottom rotation plate 665, and is threadedly engaged with a lock-nut 690 which is fastened against the bottom surface of the bottom rotation plate. Optionally, a washer may be included between the lock-nut and the bottom rotation plate. A bushing 695 may be included in the through-holes and around the tension screw/bolt 680 for maintaining the center alignment and smooth rotation of the assembly. The screw/bolt 680 and lock-nut 690 may be fastened at an appropriate tension to allow the top rotation plate 665 to continue to rotate between the discs 670/675 or be fully engaged to temporarily lock the assembly.

A lockable turntable assembly 655 may further comprise a threaded locking knob 697 with a threaded stem 698 which may provide an additional locking function. The threaded stem 698 is threadedly engaged with one of a plurality of threaded holes 699 located radially at given increments around the two rotation plates 665. To lock rotation of the turntable assembly 655, the locking knob 697 is rotated to extend the threaded stem 698 down from the threaded hole 699 in the top plate to be threadedly engaged with a corresponding threaded hole 699 in the bottom plate. To unlock rotation, the locking knob is rotated in the opposite direction to retract the threaded stem 698 from the threaded hole in the bottom plate to therefore allow rotation of the top plate. According to one embodiment, the rotation plates 665 may comprise seventy-two threaded holes 699 to allow the plates to be locked relative to each other at 5-degree increments. According to further embodiments, rotation plates may comprise any number between four and one-hundred-eighty threaded holes.

As illustrated in FIG. 14, the height-adjustable dolly 640 further comprises a vertical adjustment assembly 700 whereby a device mount assembly 705 is vertically positioned along two vertical posts 710. The vertical adjustment assembly 700 may further comprise a third rear vertical post 710 for stability. The vertical posts comprise one or a series of two or more cylindrical structural components 713 secured together by one or more of the channel braces 156 and/or one or more of the cylinder external braces 160 as previously described. The top ends of the vertical posts 710 may be secured to a mounting plate 715 attached directly or via a washer component 58 by screws 16 through holes 720 threadedly engaged with the screw slots 11 of the vertical posts' cylindrical structural components 713. Optionally, the vertical posts 710 can be reinforced against the mounting plate 715 by corner brace connectors 65 fastened by a screw 70 to a threaded hole 722 in the mounting plate via a flat insert 80 to adapt the corresponding concave side of the corner brace to the flat bottom of the mounting plate, as previously shown in FIG. 2. According to a further embodiment, the vertical posts 710 may further comprise threaded end connectors 14 at the top ends of the posts and, instead of the screws 16, secured to the mounting plate by screws 52 through holes 725 and threadedly engaged with the threaded hole 53 in the center of the threaded end components 14.

The device mount assembly 705 may comprise a bow/ball mount assembly 119 or other device interfacing mount component such as a fluid-head mount or a ball-and-socket joint mount 131 as shown in FIGS. 24, 25, and 27 whereon a device such as a camera, lighting equipment, sound recording equipment, audio/visual equipment, sensor, robotic gimbal, robotic arm, power tool, or other equipment may be demountably engaged via the device mount plate 118 or directly on a tube module. According to one embodiment, a supported device bowl/ball mount assembly 119 and device mount plate 118 are fastened to the two tube modules 116 which are demountable engaged by screws 10 with nuts 8 in the nut channels of the vertical posts 710 whereby the device mount assembly 705 and supported device or equipment may be repositioned along the vertical posts.

According to one embodiment, as illustrated in FIGS. 12 and 14, the vertical adjustment assembly 700 is upwardly engaged on the lockable turntable assembly 655 via three turntable extension plates 730 by screws 16 through holes 735 in the extension plates and threadedly engaged with the screw slots 11 in the cylindrical structural components 713 of the vertical posts 710. Optionally, the vertical posts 710 can be reinforced against the extension plates 730 each by a corner brace connector 65 fastened by a screw 70 to a threaded hole 740 in the extension plate via a flat insert 80. According to a further embodiment, the vertical posts 710 may further comprise threaded end connectors 14 at the bottom ends and, instead of the screws 16 as shown, be secured to the extension plates 730 by bolts or screws 750 through holes 745 and threadedly engaged with the threaded end components 14.

The turntable extension plates 730 may be demountably engaged with the top rotation plate 665 by upward screws 750/752 through holes 755/757 in the top rotation plate 665 and threadedly engaged with threaded holes 760/762 in the extension plates. A washer plate 765 comprising through-holes may be inserted between the top rotation plate and the extension plates to stiffen the assembly. Optionally, for additional reinforcement a tube module 770, where extending beyond the rotation plates 665, may be demountably engaged by screws, concave base components, and nuts to the underside of one or more of the extension plates or washer plates.

The extension plates 730 thereby offset the vertical posts 710 and device mount assembly 705 and a supported device or equipment to effectively center the device or equipment directly above the rotational axis of the lockable turntable assembly 655.

According to further embodiments, the bottom ends of the vertical posts 710 may be mounted without the extension plates 730 directly to the top rotation plate 665 by screws 16 through holes 775 fastened to screw slots 11, or by screws 750 through holes 755 according to embodiments where the vertical posts include threaded end connectors 14 and there threadedly engaged with the central threaded holes 53 in the end connectors, so that the device mount assembly 705 and supported device or equipment rotate at an extended position out from the rotational axis of the lockable turntable assembly 655.

According to further embodiments, in place of the lockable turntable assembly 655, the rotational function of a height-adjustable dolly 640 may be provided by the lockable turntable assembly 195 as previously described in reference to FIGS. 5 and 10 where rotatable on the bearing 230 and the roller elements 285, or provided by the lockable turntable assembly in FIG. 19 as will be described below where rotatable on the bearing 230 alone without the roller elements 285, or provided by the lockable turntable assembly in FIG. 23 as will be described below where rotatable by only the roller elements 285.

According to further embodiments, an assortment of the modular support components may further be configured as an adjustable-level tripod stand for positioning and moving a device within a selectable range of height. As illustrated in FIGS. 15 and 16, an adjustable-level tripod stand 780 may comprise a further embodiment of a lockable turntable assembly 785 with one of the rotation plates 665 as previously described and three tube modules 790 demountably engaged with a cylindrical mount component 180 below. The inward ends of the tube modules each comprise the cylinder gooseneck end connectors 390 which are demountably engaged by screws 10 fastened to the threaded holes 430 of the central cylindrical mount component 180 which here embodies the lower static element of the turntable assembly 785.

The outward ends of the tube modules 790 also comprise the cylinder gooseneck end connectors 390 each also fastened to a cylindrical mount component 180 in each of which is a long threaded-stem foot component 385 threadedly engaged by its threaded stem 795 in the central threaded hole 495 of the cylindrical mount components. According to further embodiments where increased mobility is preferred, the foot components 385 may be replaced by the long threaded-stem casters 375. An adjustable-level tripod stand 780 can thereby be levelled by individually adjusting the vertical positions of their three threaded stems 795 in the mount components 180 depending on the slope of the ground. The foot components or the caster components may include a lock-nut 797 and a washer 798 on the threaded stem which may be used to lock the stem position to prevent unwanted rotation of the components during operation. The foot components 385 may further comprise a ball-and-socket joint 799 between the bottom end of the threaded stem 795 and the base of the foot whereby the base is pivotable for best engagement with the ground.

As illustrated in FIG. 15, an adjustable-level tripod stand 780 may further comprise a vertical track assembly 28, a device mount assembly 30, and a counterweight carriage assembly 42, as previously described in reference to FIG. 2, or in further embodiments a vertical adjustment assembly 700 and device mount assembly 705, as previously described in reference to FIG. 14, whereby a supported device or equipment may be positioned or moved vertically and rotated 360 degrees on the turntable assembly 785. The bottom end of a vertical track assembly or a vertical adjustment assembly may be secured to the rotation plate 665 by upward screws 750 through holes 755 where the ends include threaded end components 14, or according to further embodiments, attached directly or via a washer component 58 by screws 16 through holes 775 threadedly engaged with the screw slots 11 of the vertical assemblies' cylindrical structural components. According to further embodiments, the vertical track assembly or vertical adjustment assembly may be demountably engaged to the lockable turntable assembly 785 via turntable extension plates 730 fastened to the rotation plate 665 by screws as previously described in reference to FIGS. 13 and 14.

According to this embodiment, the rotation plate 665 is rotatable 360 degrees within an upper low-friction disc 800 against its top surface and a lower low-friction disc 805 below between it and the cylindrical mount component 180. A rotation tension screw or bolt 810 passes through a central through-hole 815 in the upper disc 800, the through-hole 685 in the center of the rotation plate 665, a central through-hole 820 in the lower disc 805, and there threadedly engaged with the central threaded hole 495 in the cylindrical mount component 180. Optionally, a washer may be included between the screw/bolt head and the upper disc 800. The screw/bolt 810 may be fastened at an appropriate tension to allow the rotation plate 665 to continue to rotate between the discs 800/805 or be fully engaged to temporarily lock the assembly. Optionally the screw/bolt may be long enough to extend through the cylindrical mount component 180 to where it can be threadedly engaged by a lock-nut 825 against the bottom surface of the mount component to more securely lock the turntable assembly 785. Optionally, a washer may be included between the lock-nut 825 and mount component. A bushing 828 may be included in the through-holes and around the tension screw/bolt 810 for maintaining the center alignment and smooth rotation of the assembly.

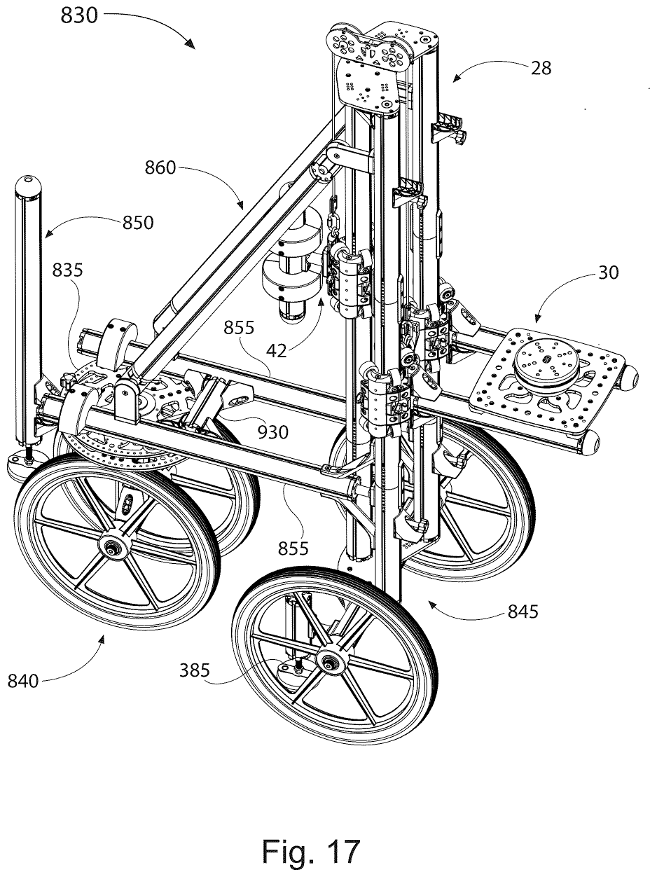

According to further embodiments, an assortment of the modular support components may further be configured as a steerable vertical track dolly or a steerable height-adjustable dolly for controllably rolling a supported device or equipment within a selectable range of height along the vertical modules. As illustrated in FIGS. 17 to 19, a steerable vertical track dolly 830 comprises a further embodiment of a lockable turntable assembly 835 configured for steering a rotating rear axle assembly 840 and rear wheels of the dolly whereby a device mount assembly 30, counterweight carriage assembly 42, and vertical track assembly 28 supported on a front axle assembly 845 can be directionally moved by turning the rear axle assembly 840 and pushing the dolly using a handle assembly 850. The rotating rear axle assembly 840 is attached via the lockable turntable assembly 835 near the rear ends of two horizontal chassis tube modules 855 and to which the vertical track assembly 28 is attached to the front ends.

The steerable dolly 830 may further comprise three long threaded-stem foot components 385 whereon the dolly may be temporarily positioned and levelled. Optionally, depending on the selected height of the vertical track assembly 28 and weight of the device mount assembly 30 and supported device or equipment, the steerable dolly may also comprise one or two of a diagonal support tube module 860 spanning between one or both of the horizontal chassis tube modules 855 and the corresponding vertical rail 32. According to additional embodiments, in place of the vertical track assembly 28, device mount assembly 30, and counterweight carriage assembly 42, a steerable dolly may instead comprise the vertical adjustment assembly 700 and device mount assembly 705, as previously described. Optionally, for added stability a steerable dolly 830 may further comprise one or more weight components 45 may be demountably engaged by screws with nuts in the nut channels along the chassis tube modules 855 or another tube module of the base of the dolly to counterbalance the weight of the vertical track assembly 28 and supported components, or of the vertical adjustment assembly 700 and supported components.

According to one embodiment, as illustrated in FIG. 19, the lockable turntable assembly 835 comprises two of the rotation plates 665 whereby a rotational bearing 230 is engaged allowing the bottom plate 665 to rotate 360 degrees relative to the top plate. The rotational bearing 230 is fastened by screws 232 through holes in its outer ring 234 and there threadedly engaged with threaded holes 865 in the top rotation plate 665 (shown indicated on the matching bottom rotation plate). A bearing retainer 870 with a central threaded hole 875 is mounted between the inner ring 243 of the bearing 230 and the bottom rotation plate 665, there fastened by screws 880 through the bottom plate and through holes in the bearing retainer 870 and threadedly engaged with threaded holes 246 in the inner ring of the bearing 230. As like the circular recess 250 on the previous embodiment of rotation plate 197 as indicated in FIG. 10, the rotation plate 665 also comprises a circular recess which matches the diameter of the inner ring of the bearing 230 so that the inner ring does not make contact with the underside of the top rotation plate 665, therefore allowing the outer ring, while fastened to the top plate, to rotate around the inner ring 243.

The lockable turntable assembly 835 may further comprise the threaded locking knob 697 with threaded stem 698 which may provide a locking function by threadedly engaging and disengaging the threaded stem 698 in one of the plurality of the threaded holes 699 located radially at given increments around the two rotation plates 665, as previously described in reference to FIG. 13.

Optionally, the lockable turntable assembly 835 may comprise a tension screw or bolt 885 of which a threaded portion is passed through the through-hole 685 in the center of the top rotation plate 665 and through the inner ring of the bearing 230 and there threadedly engaged with the central threaded hole 875 in the bearing retainer 870. The low-friction rotation disc 670 may be installed between the head of the tension screw/bolt 885 and the top of the rotation plate 665. A washer may also be included between the head of the screw/bolt 885 and the rotation disc 670. Tightening the tension screw/bolt 885 to a medium setting slows rotation of the bottom rotation plate 665 moving with the screw/bolt 885 and the rotation disc 670 sliding against the static upper rotation plate 665, or at full tension locks rotation. A lock-nut 890 may be provided under the bottom rotation plate 665, and the screw/bolt 885 threaded through the bearing retainer 240 to pass through the center through-hole 685 in the bottom rotation plate where the lock-nut 890 can be engaged onto the screw/bolt and against the bottom of the plate. A bushing 895 may also be optionally installed through the center through-hole 685 of the top rotation plate 665 to maintain the central alignment of the rotation disc 670.

According to further embodiments, in place of the lockable turntable assembly 835, the steering function of a steerable dolly 830 may be provided by the lockable turntable assembly 195 as previously described in reference to FIGS. 5 and 10 where including the bearing 230 and the roller elements 285, or provided by the lockable turntable assembly 655 as previously described in reference to FIG. 13 where rotatable on a low-friction disc 675, or provided by the lockable turntable assembly in FIG. 23 as will be described below where rotatable by only the roller elements 285.

As illustrated in FIG. 19 according to one embodiment comprising the lockable turntable assembly 835, the upper rotation plate 665 is demountably engaged by screws 190 of which a threaded portion is passed through a hole 900 in the rotation plate and through the center of the concave base components 136 and threadedly engaged with nuts 8 within the nut channels on the underside of the chassis tube modules 855.

According to one embodiment, the top end of the rear axle assembly 840 is formed by two short tube modules 905 attached perpendicularly by corner brace connectors 65 and whereby the bottom rotation plate 665 is demountably engaged by screws 190, concave base components 136, and nuts 8. Attached downwardly by corner brace connectors 65 from the upper centered tube module 905 is two additional perpendicular tube modules 905 attached by corner brace connectors 65 and whereby in the bottom horizontal module two wheels 910 are rotationally engaged by an axle screw or bolt 915 threadedly engaged with a threaded end connector 14 in each end of the horizontal module. Optionally, a brace plate 175 may be secured by screws and concave base components to the horizontal axle tube module and the adjacent vertical tube module for additional reinforcement.

According to one embodiment, the vertical track assembly 28 or vertical adjustment assembly 700 is attached securely to the front ends of the horizontal chassis tube modules 855 by a cylinder gooseneck end connector 390 at the end of each module, as well as one or more of a narrow corner brace component 920 demountably engaged by screws 10 with nuts 8 within a nut channel in the underside and/or topside of one or both of the chassis modules 855 and within the perpendicular nut channel of the corresponding cylindrical structural component of the vertical track assembly or vertical adjustment assembly. Where in use in conjunction with the three-sided roller carriage assemblies 38 on a vertical track assembly 28 as previously described in reference to FIG. 2, the gooseneck end connectors 390 and the narrow corner brace components 920 provide a narrow profile and space the chassis modules away from the vertical rails such that they remain passable by the roller carriage assemblies.

According to one embodiment, as illustrated, the bottom ends of the vertical rail assemblies 32 connect the horizontal chassis tube modules 855 down to the front axle assembly 845 where the rails may be demountably engaged by upward screws 52 through holes in a lower mounting plate 50 threadedly engaged with the rails' threaded end connectors 14 as shown, or by screws 16 directly with the rails' screw slots 11 in embodiments where excluding the threaded end connectors. The mounting plate is there demountably engaged by downward screws 190 through holes in the mounting plate and concave base components 136 and threadedly engaged with nuts in the nut channels of a front axle tube module 925 and the threaded holes in two perpendicular cylindrical mount components 180 which are attached to the front tube module 925 by corner brace connectors 65. The front tube module 925 has a threaded end connector 14 at each end whereby the two front wheels 910 are rotationally engaged by two axle screws or bolts 915.

An operator may choose to reconfigure the steerable dolly from the front-facing rails and device mount assembly to side-facing rails and device mount assembly by disengaging the channel braces 156 and cylinder external braces 160 that conjoin the bottom sections of the rails from the top sections, and then demountably engaging the top sections in a sideway direction using corner brace connectors 65 along the horizontal chassis tube modules 855 and with the center back rail mounted to the short tube module 930 which bridges between the two chassis tubes and which can be repositioned anywhere along them on its corner brace connectors 65 for alignment with the vertical rails.

As noted above, an operator may push and steer the dolly 830 using the steering handle assembly 850. According to one embodiment, the steering handle assembly 850 comprises a tube module 935 demountably engaged by two corner brace connectors 65 to the axle assembly's rear tube module 905. The handle assembly may further comprise a soft threaded end component 148 and bumper component 152 for handling at the top end of the module 935. According to a further embodiment, the two corner braces 65 may be replaced by a cylinder gooseneck end component 390 at the end of the rear tube module 905. One or more additional tube modules may be included attached perpendicularly to the tube module 935 to form a T-shaped handle and other forms.

According to one embodiment, the horizontal chassis tube modules 855, the lockable turntable assembly 835, and the rear axle assembly 840 are configured in such a way that the wheels 910 remain fully passable under the chassis modules so that the wheels may be turned at least 90 degrees in both directions allowing the steerable dolly 830 to perform tight turning radiuses.

The steering handle assembly 850 may further comprise at the bottom end a threaded end connector 14 whereby a long threaded-stem foot component 385 may be threadedly engaged along its threaded stem 795 to be extended from and retracted in to the module for adjusting its length to optionally make contact with the ground whereby, in conjunction with two threaded foot components 385 attached to the front axle tube module 925, the steerable dolly 830 can be temporarily positioned and levelled. According to one embodiment, the front two foot components 385 are threadedly engaged each with the threaded end connector 14 at the bottom of a short tube module 940, each of which is demountably engaged with the front axle by a perpendicular gooseneck component 415. In addition to threadedly adjusting the three foot components in and out of their respective tube modules, they may also be adjusted toward and away from the ground by changing their modules' positions on their respective corner brace connectors 65 and perpendicular gooseneck connectors 415, which in totality provide a substantial range of levelling adjustment.

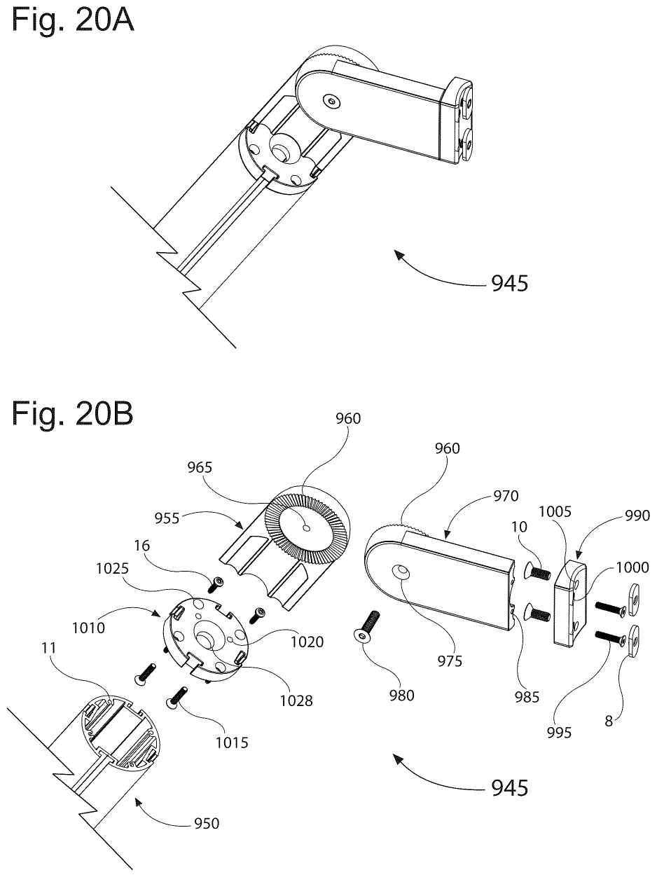

As noted above, for increased structural rigidity of the steerable dolly 830, the dolly may also comprise one or two of the diagonal support tube modules 860 extending diagonally between one or both of the horizontal chassis tube modules 855 and the corresponding vertical rail 32 or vertical post 710. According to one embodiment, a diagonal support tube module 860 comprises an adjustable angled connector 945 at both ends of an elongate cylindrical structural component 950. As illustrated in FIG. 20 according to one embodiment, the adjustable angled connector 945 comprises a threaded-hole toothed plate component 955 with a plurality of radial teeth 960 around a central threaded hole 965, which interlocks with a through-hole toothed plate component 970 having a corresponding set of radial teeth 960 around a central through-hole 975 whereby the threaded portion of a screw 980 is passed through and threadedly engaged with the threaded hole 965 of the other plate to interlock the radial teeth 960 of each plate in the grooves between the teeth of the other. According to one embodiment, each plate comprises seventy-two radial teeth 960, which allow the two toothed plate components to be interlocked at 5-degree increments. According to further embodiments, the plates may comprise any number between four and three-hundred-sixty radial teeth.

The end of each plate component 955/970 has threaded holes whereby another component may be demountably engaged for interfacing the connector with another module of a dolly or stand assembly. The through-hole toothed plate component 970 comprises two threaded holes 985 at the end of the component whereby a cylinder side mount component 990 is secured by two screws 995 through recessed through-holes 1000 and threadedly engaged with the threaded holes 985. The cylinder side mount component 990 further comprises a concave outer face whereby a cylindrical structural component, cylindrical mount component 180, roller carriage assembly 38 or other matching round component may be demountably engaged by screws 10 inserted through the opposite face of the component through recessed through-holes 1005 and threadedly engaged with nuts 8 or threaded holes.

The threaded-hole toothed plate component 955 comprises two threaded holes (not shown) at the end of the component whereby a cylinder end mount component 1010 is secured by two screws 1015 through recessed through-holes 1020 threadedly engaged with the threaded holes. The cylinder end mount component 1010 further comprises recessed through-holes 1025 whereby a threaded portion of screws 16 pass through to be threadedly engaged with the screws slots 11 of a cylindrical structural component 950. In addition to the recessed through-holes 1025 or in an embodiment which may exclude them, the cylinder end mount component 1010 may comprise a central recessed through-hole 1028 whereby a screw or bolt 210 may be used to demountably engage the adjustable angled connector 945 with a tube module having a threaded end connector 14 at its end, or with another component having a matching threaded hole.

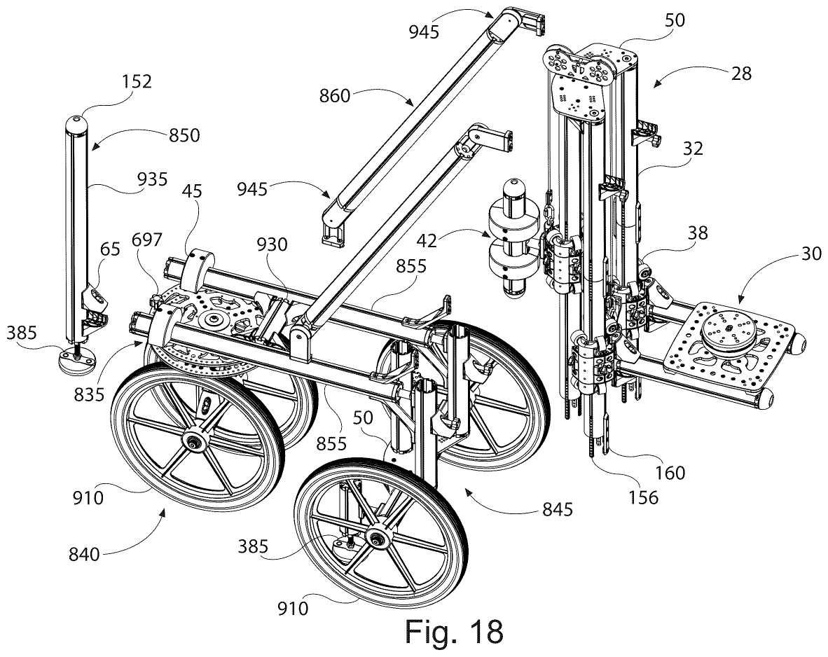

As illustrated in FIGS. 18 and 19, the two diagonal support tube modules 860 comprise the cylindrical structural component 950 whereon at both ends are fastened an adjustable angled connector 945 via the cylinder end mount component 1010. Each adjustable angled connector 945 is adjusted to an angle at which their cylinder side mount component 990 is aligned with their corresponding horizontal chassis tube module 855 or vertical rail 32, or alternatively vertical post 710, and there demountably engaged by screws 10 through recessed through-holes 1005 threadedly engaged with nuts 8 in the nut channel of the corresponding module.

According to further embodiments, an assortment of the modular support components may further be configured as a rotating jib dolly or rotating jib stand for controllably moving a supported device or equipment side to side and from low to high angles at the end of a pivoting jib arm. As illustrated in FIGS. 21 to 23, a rotating jib dolly 1030 is shown configured for rolling movement along a curved track assembly 168, as previously described. The rotating jib dolly may be reconfigured for rolling movement along an adjustable-level track assembly 165, or with the cylindrical track roller modules 170 replaced by square track roller modules 590 for rolling movement along a square or rectangular rail track assembly 595, or with the cylindrical track roller modules 170 replaced by casters 375 engaged with cylindrical mount components 180 for rolling movement directly on the ground, or with the cylindrical track roller modules 170 replaced by foot components 385 engaged with cylindrical mount components 180 for standing support directly on the ground.

As illustrated according to one embodiment, the rotating jib dolly 1030 comprises a further embodiment of a turntable dolly base 1035 with a further embodiment of a lockable turntable assembly 1040 whereby a vertical support structure 1045 is rotatable 360 degrees and supports a pivotable jib arm assembly 1050 whereon at one end is a self-levelling device mount assembly 1055 opposite a number of weight components 45 at the other end for counterbalancing the mount assembly and supported device or equipment.

According to one embodiment as illustrated, the turntable dolly base 1035 comprises a base frame assembled of six cylindrical structural components 1060, having at each end a cylinder gooseneck end component 390 secured by screws 16 to the component's screw slots 11. The four outer cylindrical structural components form the outer frame of the dolly base where at the corners four cylindrical track roller modules 170 are demountably engaged with the cylinder gooseneck end components 390. The two inner cylindrical structural components 1060 span the middle of the dolly base whereon the lockable turntable assembly 1040 is demountably engaged by downward screws 190 at through-holes 1065 in the assembly's bottom rotation plate 197, and through concave base components 136, threadedly engaged with nuts in the nut channels of the cylindrical structural components 1060.

The lockable turntable assembly 1040 is configured the same as the lockable turntable assembly 195 previously described in reference to FIGS. 5 and 10 except here excluding the rotational bearing 230 and bearing retainer 240 and rotating exclusively on the roller elements 285 on the roller track inlay 295. According to one embodiment, as illustrated, a lockable turntable assembly 1040 comprises eight roller elements 285. According to another embodiment, a lockable turntable assembly comprises four roller elements. According to further embodiments, a lockable turntable assembly comprises any number between three and twenty-four roller elements.

The rotation tension screw/bolt 255, low-friction disc 265, and lock-nut 275 may again be included at the center through-holes 260 of the rotation plates 197, but where excluding the bearing and bearing retainer, here instead a stack of bushings or an elongate bushing 1070 extends from the low-friction disc 265 down to the lock-nut 275 around the tension screw/bolt 255 to maintain the central alignment of the turntable assembly 1040 and optionally provide tension or lock the assembly. The lockable turntable assembly may be additionally or alternatively locked by the threaded locking knob 330, as previously described.

According to further embodiments, in place of the dolly base's lockable turntable assembly 1040, the rotational functions may be provided by the lockable turntable assembly 195 as previously described in reference to FIGS. 5 and 10 where rotatable on the bearing 230 and the roller elements 285 combined, or provided by the lockable turntable assembly 655 as previously described in reference to FIG. 13 where rotatable on a low-friction disc 675, or provided by the lockable turntable assembly 835 as previously described in reference to FIG. 19 where rotatable on the bearing 230 alone without the roller elements 285.

The vertical support structure 1045 is mounted to the top rotation plate 197 by upward screws 190 at through-holes 1075, and through concave base components 136, threadedly engaged with nuts 8 in the nut channels of two cylindrical structural components 1080 spanning the lower end of the vertical support structure 1045. At both ends of the cylindrical structural components 1080 a cylinder gooseneck end connector 390 connects the components with two more cylindrical structural components 1085 whereon are engaged by corner brace connectors 65, or alternatively cylinder gooseneck end connectors 390, four elongate cylindrical structural components 1090 forming the four corner posts of the vertical support structure. Four of the cylindrical structural components 1080 with cylinder gooseneck end connectors 390 bridge the vertical cylindrical structural components 1090 near the top.

The pivotable jib arm assembly 1050 comprises two lockable turntable assemblies 835, as previously described in reference to FIG. 19, here oriented vertically and each one mounted midway along the sides of two arm module assemblies 1095. According to one embodiment, the elongate component of each arm module 1095 may comprise a single cylindrical structural component, or according to one embodiment as illustrated, the arm modules comprise two cylindrical structural components 1100 which are conjoined by channel braces 156 and cylinder external braces 160, as previously described, in the nut channels of the cylindrical structural components 1100. A lockable turntable assembly 835 is mounted to the sides of both arm modules 1095, by screws 190, at through-holes 900 and through concave base components 136, threadedly engaged with nuts 8 in the nut channels of the arm modules, there securing the two arms and two turntable assemblies together. The outer rotation plate 665 of each turntable assembly 835 is demountably engaged with the vertical support structure's two upper cylindrical structural components 1080 on each side by screws 190, at through-holes 900 and through concave base components 136, threadedly engaged with nuts 8 in the nut channels of the cylindrical structural components 1080. The arm modules 1095 are thereby pivotable vertically on the vertical support structure 1045. The height of the arm can be adjusted by repositioning the upper cylindrical structural components 1080 on their cylinder gooseneck end connectors 390 along the nut channels of the vertical cylindrical structural components 1090.

The self-levelling device mount assembly 1055 is demountably engaged to the front end of the arm modules 1095 by screws 190, concave base components 136, and nuts 8 at the through-holes 900 in the inner rotation plates 665 of two additional lockable turntable assemblies 835 which are provided as the pivot mechanism of the device mount assembly 1055. Two cylindrical structural components 1105 with cylinder gooseneck end connectors 390 at each end are mounted vertically to the outer two rotation plates 665 by screws, concave base components, and nuts. Another cylindrical structural component 1109 is attached horizontally at the bottom of via the two cylinder gooseneck end connectors 390, and whereon a plurality of weight components 45 are demountably engaged by screws and nuts. Attached perpendicularly at the top ends are two cylindrical structural components 1111 whereon a device mount plate 118, bowl/ball mount assembly 119 or other interfacing mount component, and the supported device or equipment are demountably engaged where it may be manually tilted by the operator or is otherwise gravitationally levelled by the under-slung weight components 45. According to further embodiments, the lower weight components 45 can be excluded and the device mount components and supported device or equipment under-slung.

A plurality of weight components 45 are demountably engaged by screws and nuts at the opposite end of the arm modules 1095 for counterbalancing the front device mount assembly 1055 and supported device or equipment. A short cylindrical structural component 1113 attached by corner brace connectors 65, or alternatively by cylinder gooseneck end connectors 390, may be used to there reinforce the jib arm assembly 1050. According to further embodiments, the counterbalancing weight components may be excluded and a second top-slung or under-slung device mount assembly provided at the second end for a dual-device support apparatus.

As illustrated according to one embodiment, the lockable turntable assemblies 835 of the jib arm assembly 1050 and the device mount assembly 1055 may include the threaded locking knob 697 and/or the tension screw/bolt 885 assembly for locking or tensioning the pivotable movement of the mounted components.

According to further embodiments, in place of the jib arm and device mount assemblies' lockable turntable assemblies 835, the rotational functions may be provided by the lockable turntable assembly 195 as previously described in reference to FIGS. 5 and 10 where rotatable on the bearing 230 and the roller elements 285 combined, or provided by the lockable turntable assembly 655 as previously described in reference to FIG. 13 where rotatable on a low-friction disc 675, or provided by the lockable turntable assembly 1040 as previously described in reference to FIG. 23 where rotatable on the roller elements 285 alone.

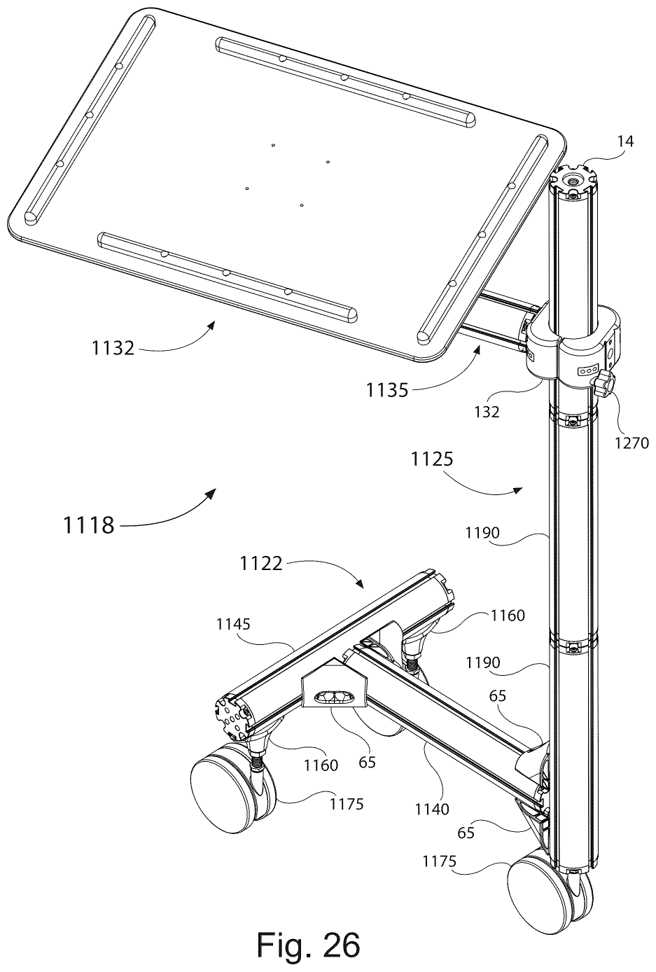

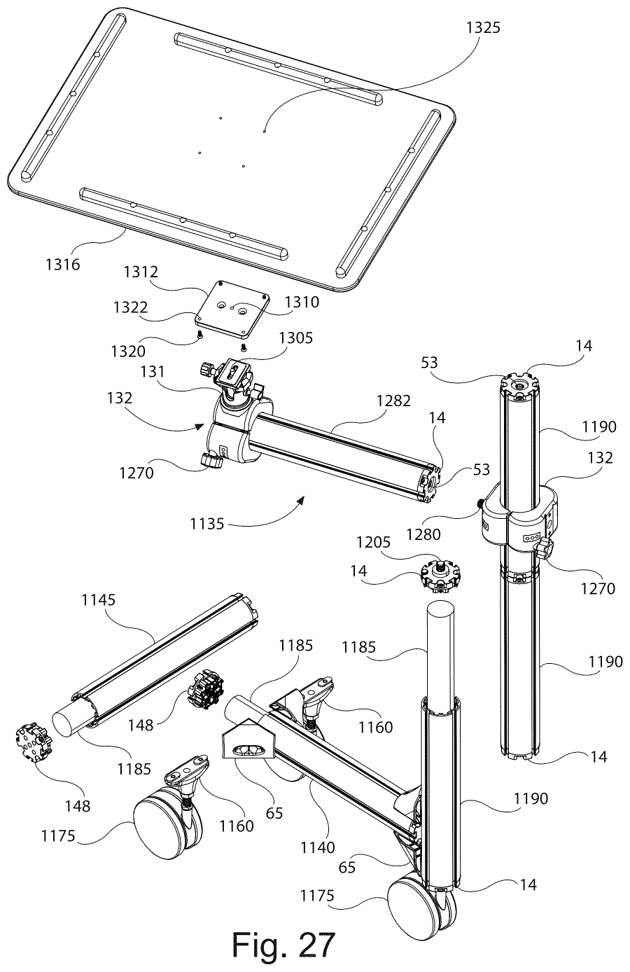

According to further embodiments, an assortment of the modular support components may further be configured as illustrated in FIGS. 24 and 25 as a reconfigurable portable device stand 1115 for supporting a device such as a laptop computer, tablet, camera, lighting equipment, sound recording equipment, audio/visual equipment, sensor, robotic gimbal, robotic arm, power tool, or other equipment, or as illustrated in FIGS. 26 and 27 configured as a reconfigurable portable table stand 1118. A close-up view of one of the embodiments of a threaded end connector 18 is shown in FIG. 28.

A reconfigurable portable device stand 1115 or a reconfigurable portable table stand 1118 may comprise a base assembly 1122 from which extends vertically an upright support assembly 1125 wherefrom a device mount assembly 1130 and supported device or a table assembly 1132 is extended on an arm assembly 1135.

According to one embodiment, the base assembly 1122 comprises a first cylindrical structural component 1140 demountably engaged with a second cylindrical structural component 1145 in a perpendicular T-shape by two corner brace connectors 65 fastened by threaded portions of screws 10 passed through through-holes 72/73 to be threadedly engaged with nuts 8 in the nut channels 1150/1155 of the cylindrical structural components. According to a further embodiment, the corner brace connectors are replaced by a cylindrical gooseneck end connector 390, as previously described, fastened by screws 16 to the screw slots 11 in the end of the first cylindrical structural component 1140, and fastened by screws 10 to nuts 8 in the nut channel 1155 of the second cylindrical structural component 1145. The base assembly 1122 may further comprise a plurality of a threaded side mount component 1160 demountably engaged by screws 1165 at through-holes 1170 threadedly engaged with nuts 8 in the bottom nut channels of the cylindrical structural components 1140/1145. As illustrated, threaded-stem casters 1175 may be threadedly engaged with a threaded hole 1180 in the center of the threaded side mount components 1160, or according to further embodiments, threaded-stem foot components. For increased stability, weight components 45, as previously described, may be demountably engaged with one or both of the base assembly's cylindrical structural components 1140/1145, or as illustrated in FIG. 27, an internal weight component 1185 such as one or more steel segments or one or more sandbags may be installed within the hollow components. Threaded end connectors 14 as previously described, or threaded end connectors 18 as will be described below, or soft threaded end components 148 as previously described may be installed at the ends of the cylindrical structural components 1140/1145. According to a further embodiment, the second cylindrical structural component 1145 may be replaced by a wide foot component demountably engaged to the underside of the first cylindrical structural component 1140.

A reconfigurable portable device stand 1115 or a reconfigurable portable table stand 1118 further comprise an upright support assembly 1125 having one or more cylindrical structural components 1190 extending upward from the base assembly 1122. According to one embodiment as illustrated, a first upright cylindrical structural component 1190 is demountably engaged by corner brace connectors 65 perpendicular with the end of the base cylindrical structural component 1140, or alternatively the base component 1140 has a cylindrical gooseneck end connector 390 at the end whereby it is demountably engaged with the upright component 1190. The bottom end of the upright component 1190 may comprise a threaded end connector 14/18 whereby a threaded-stem caster 1175 or threaded-stem foot is threadedly engaged.

According to further embodiments, a base assembly may comprise two cylindrical structural components extending from the upright support assembly in an L-shape, or it may comprise three cylindrical structural components extending in an A-shape or a Y-shape or an H-shape, or it may comprise four cylindrical structural components extending in an X-shape.

In embodiments where the upright support assembly 1125 includes two or more conjoined upright cylindrical structural components 1190, the components may be demountably engaged by two of threaded end connector 14 or two of threaded end connector 18. The two threaded end connectors 14/18 are fastened at the corresponding cylinder ends by the threaded portion of screws 16 passed through recessed screw through-holes 1195/1200 and threadedly engaged with the screw slots 11 in the cylindrical structural components 1190. A connector screw 1205 has been threadedly engaged into a central threaded hole 53/1210 of the first threaded end connector on the first cylindrical structural component 1190 with the screw head then contained by the first cylindrical structural component 1190. The threaded end of the connector screw 1205 extends from the first threaded end connector whereby the second threaded end connector and corresponding second cylindrical structural component 1190 can be manually rotated by threaded engagement of its central threaded hole 53/1210 onto the connector screw. According to one embodiment, the connector screw 1205 is secured into the first threaded end component by a glue or an epoxy or thread-locker or other adhesive to prevent disengagement when being installed into the second threaded end connector. According to one embodiment, the threaded end connectors 14/18 further comprise nut channel openings 1212 which allow nuts 8 to be moved through the connectors into and out of the nut channels of cooperating cylindrical structural components.

Threaded end connectors 14/18 may further comprise a circular recess 1215/1220 around the central threaded hole 53/1210 wherein a circular insert 1225/1230 made of a resiliently compressible material such as a foam or a rubber material is installed into one or both the first and second threaded end connectors to provide a range of tension so that the connectors can be securely engaged and then disengaged by manual rotation. As illustrated in FIG. 25 according to one embodiment, a single circular insert 1225 is installed in the circular recess 1215 of the first threaded end connector 14 and protrudes from the recess to be received and make contact in the circular recess 1215 of the second threaded end connector 14 where it maintains a narrow gap between the end faces of the connectors wherein the circular insert is compressible until the connectors are adequately engaged and aligned.

As illustrated in FIG. 28 according to a further embodiment, a circular insert 1230 is installed in the circular recesses 1220 of both the first and the second threaded end connectors 18 from where they protrude to make contact while maintaining a narrow gap between the end faces of the connectors wherein the circular inserts 1230 are compressible until the connectors are adequately engaged and aligned.

According to some embodiments, the circular inserts 1225/1230 are secured within the circular recesses by a glue or an epoxy or other adhesive. According to some embodiments, a hard insert such as a washer or spacer 1235 is inserted between the compressible inserts 1225/1230 and the bottom of the recess as a filler component where required depending on the thickness of the compressible inserts and their required extension out of the recess.

According to some embodiments, a thumb-screw 1240 is provided in place of one of the four screws 16 of one of the threaded end connectors 14/18 and threadedly engaged in the corresponding screw slot 11 to provide a rotation locking function. The head diameter of the thumb-screw fits just within the size of the recess around its screw through-hole 1195/1200 in the first threaded end connector 14/18, where it may be threadedly engaged in to be contained by the recess, or be threadedly extended out of its recess to protrude into a corresponding recess of the aligned second threaded end connector 14/18, where therefore the two connectors cannot be disengaged until the thumb-screw is withdrawn.

A reconfigurable portable device stand 1115 or a reconfigurable portable table stand 1118 further comprise an arm assembly which is extended from the upright support assembly and from which a device mount assembly and supported device or a table assembly is extended and positioned. According to one embodiment, the arm assembly 1135 comprises a clamp assembly 132 which is clamped along the one or more cylindrical structural components 1190 of the upright support assembly 1125. Two half-clamp components 1250 are demountably engaged with one another by screws 1255 engaged in through-holes 1260 in one and threadedly engaged with threaded holes 1265 in the other. The screws can be set to a position such that necessarily loosening only one releases the clamp so that it may be raised and lowered and pivoted along the cylindrical structural component(s) 1190 and then resecured. According to one embodiment, the releasing screw is a threaded knob 1270.

The half-clamp component 1250 further comprises a central recessed through-hole 1275 in which a screw 1280 is engaged outwardly through the hole and where the screw head is contained by the recess so that it does not interfere with the corresponding cylindrical structural component 1190. A threaded portion of the screw 1280 is extended outwardly whereby a cylindrical structural component 1282 with a threaded end connector 14/18 is threadedly engaged by the screw 1280. According to some embodiments, the arm assembly 1135 may comprise two or more cylindrical structural components conjoined end to end. According to further embodiments, the clamp assembly 132 is excluded and the connecting end of the cylindrical structural component 1282 is demountably engaged via corner brace connectors 65 by screws with nuts in the nut channels, or the connecting end of the cylindrical structural component 1282 is provided with a cylinder gooseneck end connector 390 in place of the threaded end connector 14/18 whereby the arm component is demountably engaged by screws with nuts in the nut channels of the upright support assembly 1125.

The half-clamp component 1250 may also comprise two angled threaded inserts 1285 secured by outward screws in recessed through-holes, whereby another component may be secured by a screw threadedly engaged with a threaded hole in the insert. Alternatively, a threaded insert may be removed and a longer screw outwardly installed to receive a component with a threaded hole. As shown in FIG. 25, a cup holder component 1290 is threadedly engaged with an outward screw 1295.

According to one embodiment, a second clamp assembly 132 is provided on the cylindrical structural component 1282 of the arm assembly 1135 whereon the device mount assembly 1130 or the table assembly 1132 is pivotable and slidable. As illustrated in FIGS. 25 and 27, optionally a ball-and-socket joint mount 131 is provided as an interfacing mount component between the arm assembly 1135 and the device mount assembly 1130 or the table assembly 1132. As illustrated according to one embodiment, the joint mount 131 is secured by an outward screw 1300 passed through a concave base component 136 and threadedly engaged with a threaded hole in the bottom of the joint mount 131. A mount screw 1305 at the other end of the ball-and-socket joint mount 131 is threadedly engaged with a threaded hole 1310 in a mount plate 1312 whereby a laptop computer bracket 1315 or a table component 1316 is secured by screws 1320 in through-holes 1322 in the mount plate 1312 there threadedly engaged with threaded holes 1323 in the backside of the laptop computer bracket 1315 or with threaded holes 1325 in the backside of the table component 1316.

According to further embodiments, a portable device stand 1115 can exclude the mount plate 1312 and the laptop computer bracket 1315 and table component 1316 to directly mount a device such as a camera, light, microphone, audio/visual equipment, sensor, robotic gimbal, robotic arm, power tool, or other equipment or additional interfacing mount component such as a tablet bracket on the ball-and-socket joint mount 131 via its screw mount 1305.

While embodiments of the disclosure have generally been presented in the context of modular components and modular assemblies, the disclosure extends to non-modular components and assemblies (e.g., components and assemblies that may not be modular with other components and assemblies, or that may consist of “one-piece” components or assemblies).

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is furthermore contemplated that any part of any aspect or embodiment discussed in this specification can be implemented or combined with any part of any other aspect or embodiment discussed in this specification.

NUMBERING KEY

| | |
|---|---|
| 3 | cylindrical structural component |
| 5 | nut channel |
| 8 | nut |
| 10 | screw |
| 11 | screw slots |
| 14 | threaded end connector |
| 16 | screw |
| 18 | threaded end connector |
| 20 | tube module |
| 22 | vertical track dolly |
| 25 | turntable dolly base |
| 28 | 3-rail vertical track assembly |
| 30 | device mount assembly |
| 32 | vertical rail assembly |
| 35 | pulley assembly |
| 38 | three-sided roller carriage assembly |
| 40 | cable |
| 42 | counterweight carriage assembly |
| 45 | weight component |
| 47 | adjustable clamping mechanism |
| 50 | mounting plate |
| 52 | screw |
| 53 | end connector threaded hole |
| 55 | through-hole |
| 58 | washer component |
| 60 | through-holes |
| 65 | corner brace connector |
| 70 | screw |
| 72 | first through-hole |
| 73 | second through-hole |
| 75 | threaded hole |
| 80 | corner brace flat insert |
| 85 | pulley bracket |
| 90 | pulley |
| 92 | pulley axle holes |
| 95 | binding barrel |
| 97 | binding barrel screw |
| 100 | bushing |
| 102 | cable retainer |
| 105 | screw |
| 107 | threaded holes |
| 110 | roller carriage bridge component |
| 111 | threaded hole |
| 112 | eyebolt |
| 114 | screw |
| 115 | threaded hole |
| 116 | tube module |
| 118 | device mount plate |
| 119 | bowl/ball mount assembly |
| 120 | ball adapter threaded hole |
| 121 | screw |
| 122 | bowl mount component |
| 125 | mount plate threaded hole |
| 126 | ball adapter |
| 128 | screw/bolt |
| 130 | locking handle |
| 131 | ball-and-socket joint mount |
| 132 | clamp bracket assembly |
| 134 | nut channel |
| 135 | cylindrical structural component |
| 136 | concave base component |
| 138 | screw |
| 140 | bumper component |
| 142 | eyebolt |
| 144 | tube module |
| 146 | screw |
| 148 | soft threaded end component |
| 150 | cylindrical structural component |
| 152 | bumper component |
| 154 | parallel gooseneck connector |
| 156 | channel brace |
| 158 | set screw |
| 160 | cylinder external brace |
| 162 | threaded knob |
| 165 | adjustable-level track assembly |
| 168 | standard curved track assembly |
| 170 | cylindrical track roller module |
| 175 | brace plate |
| 177 | screw |
| 178 | threaded hole |
| 180 | cylindrical mount component |
| 185 | tube modules |
| 190 | screw |
| 195 | lockable turntable assembly |
| 197 | rotation plate |
| 198 | through-hole |
| 200 | turntable extension plate |
| 205 | screw |
| 210 | screw |
| 211 | screw |
| 213 | through-hole |
| 214 | through-hole |
| 215 | threaded hole |
| 216 | threaded hole |
| 220 | washer plate |
| 221 | tube module |
| 222 | through-holes |
| 224 | through-holes |
| 230 | rotational bearing |
| 232 | bearing screws |
| 234 | outer bearing ring |
| 236 | threaded holes |
| 240 | bearing retainer |
| 242 | central threaded hole |
| 243 | bearing inner ring |
| 245 | retainer screws |
| 246 | threaded holes |
| 250 | circular recess |
| 255 | rotation tension screw/bolt |
| 260 | center through-hole |
| 265 | low-friction rotation disc |
| 270 | washer |
| 275 | rotation lock-nut |
| 280 | rotation bushing |
| 285 | roller element |
| 290 | screw |
| 292 | threaded holes |
| 295 | roller track inlay |
| 300 | screw |
| 302 | threaded hole |
| 305 | roller |
| 310 | axle screw |
| 315 | threaded hole |
| 320 | roller mount |
| 325 | non-metallic insert |
| 330 | threaded locking knob |
| 335 | threaded stem |
| 340 | radial threaded holes |
| 355 | horizontal rail assembly |
| 360 | cylindrical structural component |
| 365 | height-adjustable track end assembly |
| 370 | vertical post tube module |
| 372 | central tube module |
| 375 | long threaded-stem caster |
| 377 | threaded stem |
| 380 | cylindrical structural component |
| 385 | long threaded-stem foot components |
| 387 | stem lock-nut |
| 388 | stem washer |
| 390 | cylinder gooseneck end connector |
| 395 | height-adjustable cross-support assembly |
| 400 | vertical post tube module |
| 405 | cylindrical structural component |
| 410 | cylindrical structural component |
| 415 | perpendicular gooseneck connector |
| 420 | push handle assembly |
| 425 | tube module |
| 430 | threaded hole |
| 435 | upper body component |
| 440 | lower body component |
| 445 | screw |
| 450 | hole |
| 455 | threaded hole |
| 460 | vibration/noise reduction gasket |
| 465 | recess |
| 470 | noise reduction inserts |
| 475 | upper pivot shoulder screw |
| 480 | low-friction upper pivot disc |
| 485 | upper bushing |
| 490 | through-hole |
| 492 | through-hole |
| 495 | threaded hole |
| 500 | lower pivot shoulder screw |
| 505 | lower bushing |
| 510 | lower bushing slot |
| 515 | through-hole |
| 520 | low-friction lower pivot disc |
| 525 | lock-nut |
| 530 | recessed through-hole |
| 535 | screw |
| 540 | threaded hole |
| 545 | roller mount plate |
| 547 | lock-nut hole |
| 550 | diameter-adjustment roller mount holes |
| 555 | roller mount |
| 560 | screw |
| 565 | roller |
| 570 | axle screw |
| 575 | threaded hole |
| 580 | vertical track dolly |
| 585 | turntable dolly base |
| 590 | square track roller module |
| 595 | rectangular rail track assembly |
| 600 | cylindrical structural component |
| 605 | through-holes |
| 610 | curved square rail component |
| 615 | square rail roller mount |
| 616 | roller mount plate |
| 618 | screw |
| 620 | roller |
| 625 | vertical shoulder screw |
| 630 | horizontal shoulder screw |
| 635 | vertical roller spacer |
| 640 | height-adjustable dolly |
| 645 | turntable dolly base |
| 650 | tube module |
| 655 | lockable turntable assembly |
| 660 | through-hole |
| 665 | turntable rotation plate |
| 670 | upper low-friction disc |
| 675 | lower low-friction disc |
| 680 | rotation tension screw/bolt |
| 682 | upper disc through-hole |
| 685 | plate central through-hole |
| 688 | lower disc through-hole |
| 690 | rotation lock-nut |
| 695 | rotation bushing |
| 697 | threaded locking knob |
| 698 | threaded stem |
| 699 | threaded holes |
| 700 | vertical adjustment assembly |
| 705 | device mount assembly |
| 710 | vertical post |
| 713 | cylindrical structural component |
| 715 | mounting plate |
| 720 | through-holes |
| 722 | threaded hole |
| 725 | through-hole |
| 730 | turntable extension plate |
| 735 | through-hole |
| 740 | threaded hole |
| 745 | through-hole |
| 750 | screw |
| 752 | screw |
| 755 | through-hole |
| 757 | through-hole |
| 760 | threaded hole |
| 762 | threaded hole |
| 765 | washer plate |
| 770 | tube module |
| 775 | through-holes |
| 780 | adjustable-level tripod stand |
| 785 | lockable turntable assembly |
| 790 | tube modules |
| 795 | threaded stem |
| 797 | threaded stem lock-nut |
| 798 | threaded stem washer |
| 799 | foot ball-and-socket joint |
| 800 | upper low-friction disc |
| 805 | lower low-friction disc |
| 810 | rotation tension screw/bolt |
| 815 | upper disc through-hole |
| 820 | lower disc through-hole |
| 825 | rotation lock-nut |
| 828 | rotation bushing |
| 830 | steerable vertical track dolly |
| 835 | lockable turntable assembly |
| 840 | rotating rear axle assembly |
| 845 | front axle assembly |
| 850 | steering handle/foot assembly |
| 855 | horizontal chassis tube module |
| 860 | diagonal support tube module |
| 865 | bearing threaded holes |
| 870 | bearing retainer |
| 875 | retainer threaded hole |
| 880 | retainer screws |
| 885 | rotation tension screw/bolt |
| 890 | lock-nut |
| 895 | bushing |
| 900 | plate through-hole |
| 905 | short tube module |
| 910 | wheel |
| 915 | axle screw/bolt |
| 920 | narrow corner brace component |
| 925 | front axle tube module |
| 930 | short chassis tube module |
| 935 | handle tube module |
| 940 | foot tube module |
| 945 | adjustable angled connector |
| 950 | cylindrical structural component |
| 955 | threaded-hole toothed plate |
| 960 | radial teeth |
| 965 | threaded hole |
| 970 | through-hole toothed plate |
| 975 | through-hole |
| 980 | screw |
| 985 | threaded hole |
| 990 | cylinder side mount component |
| 995 | screw |
| 1000 | recessed through-hole |
| 1005 | recessed through-hole |
| 1010 | cylinder end mount component |
| 1015 | screw |
| 1020 | recessed through-hole |
| 1025 | recessed through-hole |
| 1028 | central through-hole |
| 1030 | rotating jib dolly |
| 1035 | turntable dolly base |
| 1040 | lockable turntable assembly |
| 1045 | vertical support structure |
| 1050 | pivotable jib arm assembly |
| 1055 | self-levelling device mount assembly |
| 1060 | cylindrical structural component |
| 1065 | through-hole |
| 1070 | elongate bushing |
| 1075 | through-hole |
| 1080 | cylindrical structural component |
| 1085 | cylindrical structural component |
| 1090 | cylindrical structural component |
| 1095 | arm module assembly |
| 1100 | cylindrical structural component |
| 1105 | cylindrical structural component |
| 1109 | cylindrical structural component |
| 1111 | cylindrical structural component |
| 1113 | cylindrical structural component |
| 1115 | portable device stand |
| 1118 | portable table stand |
| 1122 | base assembly |
| 1125 | upright support assembly |
| 1130 | device mount assembly |
| 1132 | table assembly |
| 1135 | arm assembly |
| 1140 | cylindrical structural component |
| 1145 | cylindrical structural component |
| 1150 | nut channel |
| 1155 | nut channel |
| 1160 | threaded side mount component |
| 1165 | screw |
| 1170 | through-holes |
| 1175 | threaded-stem caster |
| 1180 | threaded hole |
| 1185 | internal weight component |
| 1190 | cylindrical structural component |
| 1195 | recessed through-hole |
| 1200 | recessed through-hole |
| 1205 | connector screw |
| 1210 | central threaded hole |
| 1212 | nut channel opening |
| 1215 | circular recess |
| 1220 | circular recess |
| 1225 | circular insert |
| 1230 | circular insert |
| 1235 | spacer |
| 1240 | thumb-screw |
| 1250 | half-clamp component |
| 1255 | screw |
| 1260 | through-hole |
| 1265 | threaded hole |
| 1270 | threaded knob |
| 1275 | central recessed through-hole |
| 1280 | screw |
| 1282 | cylindrical structural component |
| 1285 | angled threaded inserts |
| 1290 | cup holder |
| 1295 | outward screw |
| 1300 | outward screw |
| 1305 | mount screw |
| 1310 | threaded hole |
| 1312 | mount plate |
| 1315 | laptop computer bracket |
| 1316 | table component |
| 1320 | screw |
| 1322 | through-hole |
| 1323 | threaded hole |
| 1325 | threaded hole |

1. An assembly for moving a device, comprising:
roller elements for allowing the assembly to be moved by rolling the roller elements;
a vertical track assembly comprising a device mount assembly for mounting the device to the vertical track assembly;
a counterbalanced pulley system for allowing the device mount assembly to be controllably translated along the vertical track assembly; and
a turntable, at least a portion of which is rotatable relative to the vertical track assembly.

2. The assembly of claim 1, wherein:
the assembly further comprises roller assemblies comprising the roller elements; and
the roller assemblies are connected by one or more connecting members to the turntable and positioned to allow the roller elements to contact rails of a track along which the assembly is to be moved.

3. The assembly of claim 2, wherein each roller assembly has a portion that is pivotable relative to the one or more connecting members to thereby assist the assembly in moving along a curved portion of the track.

4. The assembly of claim 2, wherein:
each roller assembly comprises:
at least a pair of the roller elements; and
a roller element mount plate to which are fastened the pair of roller elements; and
the roller element mount plate comprises multiple spaced apertures for allowing the pair of roller elements to be spaced apart by different offsets to accommodate rails of different widths.

5. The assembly of claim 1, comprising one or more cylindrical structural components, each cylindrical structural component having one or more channels formed in an outer surface thereof and extending along the length of the cylindrical structural component.

6. The assembly of claim 5, wherein:
at least one of the one or more cylindrical structural components has only four channels; and
the four channels are positioned symmetrically around the cylindrical structural component.

7. The assembly of claim 5, wherein:
the assembly further comprises a track along which the assembly is to be moved; and
the track comprises at least one of the one or more cylindrical structural components.

8. The assembly of claim 5, wherein the vertical track assembly comprises at least one of the one or more cylindrical structural components.

9. The assembly of claim 5, wherein:
the assembly further comprises roller assemblies comprising the roller elements;
the roller assemblies are connected by one or more connecting members to the turntable and positioned to contact rails of a track along which the assembly is to be moved; and
the one or more connecting members comprise at least one of the one or more cylindrical structural components.

10. The assembly of claim 5, wherein:
the assembly comprises multiple cylindrical structural components; and
at least two adjacent cylindrical structural components of the multiple cylindrical structural components are joined using a brace positioned in a respective channel of each of the two adjacent cylindrical structural components.

11. The assembly of claim 1, wherein:
the turntable defines a first axis of rotation; and
the device mount assembly comprises a device mount plate for mounting the device at a mounting location on the device mount plate; and
the mounting location is aligned with the first axis of rotation.

12. The assembly of claim 11, wherein:
the vertical track assembly comprises one or more vertical rails along at least one of which the device mount assembly is controllably and vertically translatable using the pulley system; and
the one or more vertical rails are offset from a center of the turntable by one or more extension members to align the first axis of rotation with the mounting location.

13. The assembly of claim 1, wherein:
the vertical track assembly comprises one or more vertical rails along at least one of which the device mount assembly is controllably and vertically translatable using the pulley system; and
the one or more vertical rails are attached to the turntable.

14. The assembly of claim 1, wherein:
the vertical track assembly comprises vertical rails;
the device mount assembly is attached to at least one of the vertical rails using at least one first roller carriage assembly configured to be controllably translated along the at least one vertical rail; and
the pulley system:
comprises a counterweight secured to at least one of the vertical rails by at least one second roller carriage assembly; and
is connected to the at least one first roller carriage assembly and the at least one second roller carriage assembly.

15. The assembly of claim 1, wherein:
the vertical track assembly comprises first, second, and third vertical rails;
the device mount assembly is controllably and vertically translatable, using the pulley system, along the first and second vertical rails; and
the pulley system comprises a counterbalance that is controllably and vertically translatable along the third vertical rail.

16. The assembly of claim 1, wherein:
the pulley system comprises a pulley plate and one or more pulleys mounted to the pulley plate; and
the vertical track assembly further comprises one or more vertical rails to which is secured the pulley plate.

17. The assembly of claim 16, wherein the vertical track assembly further comprises:
at least one corner brace contacting the pulley plate and one of the one or more vertical rails to provide increased support to the pulley plate.

18. The assembly of claim 2, wherein:
the assembly further comprises the track;
the track comprises at least one rail connecting member interconnecting the rails; and
one or more wheels are attached to the rail connecting member for allowing the track to be rolled along the ground.

19. The assembly of claim 18, wherein:
each wheel is attached to a respective vertical post comprised in the rail connecting member; and
each vertical post is spaced from one of the rails to provide clearance for the rolling assemblies when the assembly is being moved along the track.

20. The assembly of claim 19, wherein:
each vertical post is attached to one of the rails using a respective connector comprised in the rail connecting member; and
each connector is configured to be attached to the one of the rails using a fastener received in a first channel formed within the one of the rails, and each connector is configured to be attached to the vertical post using a fastener received in a second channel formed within the vertical post.

21. The assembly of claim 20, wherein the first and second channels are perpendicular.

22. The assembly of claim 18, wherein the rail connecting member is height-adjustable relative to each wheel for allowing the track to be levelled.

23. The assembly of claim 2, wherein:
the assembly further comprises the track;
at least one of the rails is fastened to a vertical post of the track;
a wheel is attached to the vertical post for allowing the track to be rolled along the ground; and
the height of the rail relative to the wheel is adjustable by adjusting the location at which the rail is fastened to the vertical post.

24. The assembly of claim 23, wherein:
the rail is fastened to the vertical post using at least one connector; and
the height of the rail relative to the wheel is adjustable by unfastening the at least one connector, adjusting the location at which the rail is fastened to the vertical post, and fastening the at least one connector to the vertical post and the rail.

25. The assembly of claim 24, wherein the at least one connector is at least one corner brace connector.

26. The assembly of claim 2, wherein:
at least one of the one or more connecting members comprises a cylindrical structural component; and
at least one of the rolling assemblies is attached to the at least one cylindrical structural component using a connector having:
a first end that is fastened to the rolling assembly; and
a second end that covers an open end of the cylindrical structural component.

27. The assembly of claim 1, wherein the roller elements are wheels for wheeling the assembly over the ground.

28. The assembly of claim 27, wherein:
the assembly further comprises a horizontal base extending from a front of the assembly to a rear of the assembly; and
the vertical track assembly is attached to the horizontal base at the front of the assembly.

29. The assembly of claim 28, wherein:
one or more diagonal supporting members extend from proximally the rear of the assembly to proximally a top of the vertical track assembly.

30. The assembly of claim 29, wherein:
the vertical track assembly comprises a pair of vertical rails along which the device mount assembly is controllably and vertically translatable using the pulley system; and
the one or more diagonal supporting members are attached to the pair of vertical rails.

31. The assembly of claim 27, wherein:
the wheels include at least one rear wheel; and
the turntable is coupled to the at least one rear wheel such that a user of the assembly may rotate the turntable and thereby pivot the at least one rear wheel to steer the assembly.

32. The assembly of claim 1, wherein the turntable comprises a first plate rotatable relative to a second plate.

33. The assembly of claim 32, wherein the turntable further comprises one or more rollers between the first and second plates for allowing the first plate to rotate relative to the second plate.

34. The assembly of claim 32, wherein the turntable further comprises a bearing positioned between the first and second plates.

35. The assembly of claim 33, wherein the turntable further comprises rollers between the first and second plates and arranged in a circumferential direction for allowing the first plate to rotate relative to the second plate.

36. The assembly of claim 32, wherein the turntable further comprises:
a first movable disc on top of the first plate, and a second movable disc between the first and second plates; and
a threaded fastener extending through the first movable disc, the first plate, the second movable disc, and the second plate, and for allowing a user to control the resistance to rotation, or prevent rotation, of the first plate relative to the second plate by selectively tightening or loosening the fastener.

37. The assembly of claim 34, wherein the turntable further comprises:
a bearing retainer positioned between the bearing and one of the first plate and the second plate; and
a threaded fastener extending through the other of the first plate and the second plate, into the bearing retainer, and for allowing a user to control the resistance to rotation, or prevent rotation, between the first and second plates by selectively tightening or loosening the fastener.

38. An assembly comprising:
a vertical adjustment assembly comprising:
one or more vertical posts; and
a device mount assembly comprising one or more arms fastened to the one or more vertical posts and for mounting a device to the vertical adjustment assembly; and
a turntable, at least a portion of which is rotatable relative to the vertical adjustment assembly,
and wherein the one or more arms are height-adjustable relative to the ground to allow the device mount assembly to be vertically repositioned.

39. The assembly of claim 38, wherein:
the assembly further comprises a horizontal base extending from a front of the assembly to a rear of the assembly; and
the vertical adjustment assembly is attached to the horizontal base at the front of the assembly.

40. The assembly of claim 39, wherein:
one or more diagonal supporting members extend from proximally the rear of the assembly to proximally a top of the vertical adjustment assembly.

41. The assembly of claim 40, wherein:
the vertical adjustment assembly comprises a pair of vertical posts along which the device mount assembly is vertically adjustable; and
the one or more diagonal supporting members are attached to the pair of vertical posts.

42. The assembly of claim 38, wherein:
the assembly further comprises wheels, including at least one rear wheel, for allowing the assembly to be moved over the ground; and
the turntable is coupled to the at least one rear wheel such that a user of the assembly may rotate the turntable and thereby pivot the at least one rear wheel to steer the assembly.

43. The assembly of claim 38, wherein:
each of the one or more arms is attached to one of the one or more posts using at least one connector; and
the height of each arm relative to the ground is adjustable by unfastening the at least one connector, adjusting the location at which the arm is fastened to the vertical post, and fastening the at least one connector to the vertical post and the arm.

44. The assembly of claim 43, wherein the at least one connector is at least one corner brace connector.

45. The assembly of claim 38, wherein:
the turntable defines a first axis of rotation; and
the device mount assembly comprises a device mount plate for mounting the device at a mounting location on the device mount plate; and
the mounting location is aligned with the first axis of rotation.

46. The assembly of claim 45, wherein:
the vertical adjustment assembly comprises one or more vertical posts along at least one of which the device mount assembly is height-adjustable; and
the one or more vertical posts are offset from a center of the turntable by one or more extension members to align the first axis of rotation with the mounting location.

47. The assembly of claim 38, further comprising:
legs extending from a cylindrical mount component; and
feet connected to ends of the legs,
wherein the turntable is rotatable relative to the legs and connected to the cylindrical mount component by a threaded fastener extending through the turntable and into the cylindrical mount component, and for allowing a user to control the resistance to rotation of the turntable by selectively tightening or loosening the fastener.

48. The assembly of claim 47, wherein the threaded fastener further extends through the cylindrical mount component and a locking nut is engaged with the threaded fastener to lock the turntable.

49. The assembly of claim 47, wherein three or four legs extend from the cylindrical mount component.

50. The assembly of claim 47, wherein the legs are height-adjustable relative to the feet.

51. The assembly of claim 47, wherein the feet are threadably engaged to cylindrical mount portions at ends of the legs.

52. The assembly of claim 51, wherein the legs are height-adjustable relative to the feet by threadably adjusting positions of the feet relative to the cylindrical mount portions.

53. The assembly of claim 47, wherein the feet comprise caster wheels.

54. A roller assembly for moving along a rail, comprising:
an upper mount component;
an upper body component pivotable relative to the upper mount component;
a lower body component fixed to the upper body component; and
a roller element mount plate to which are secured roller elements for allowing the assembly to be moved by rolling the roller elements along the rail, wherein the roller element mount plate is:
pivotable relative to the lower body component; and
translatable along a slot formed in the lower body component.
